(19) United States
(12) Patent Application Publication
(10) Pub. No.: US 2024/0403838 A1
(43) Pub. Date: Dec. 5, 2024

(54) INQUIRY PROCESSING DEVICE AND INQUIRY PROCESSING METHOD

(71) Applicant: NABTESCO CORPORATION, Tokyo (JP)

(72) Inventors: Tomohiro HAMAKUBO, Tokyo (JP); Hiroto OKADA, Tokyo (JP); Yoshinari KIYOMASA, Tokyo (JP); Junichi MATSUNAGA, Tokyo (JP)

(21) Appl. No.: 18/802,012

(22) Filed: Aug. 13, 2024

Related U.S. Application Data
(63) Continuation of application No. 17/132,392, filed on Dec. 23, 2020.
Application No. 17/132,392 is a continuation of application No. PCT/JP2019/030029, filed on Jul. 31, 2019.

(30) Foreign Application Priority Data
Jul. 31, 2018 (JP) 2018-143892
Nov. 19, 2018 (JP) 2018-216849
Jan. 22, 2019 (JP) 2019-008755

(51) Int. Cl. G06Q 10/20; E05F 15/73; G05B 23/02; G06N 20/00; G06Q 10/0639; G06Q 10/10; G06Q 30/016; G07C 3/14; G07C 9/00

(52) U.S. Cl. CPC G06Q 10/20; E05F 15/73; G05B 23/0283; G06N 20/00; G06Q 10/06395; G06Q 10/10; G07C 3/143; G07C 9/00; E05Y 2400/512; E05Y 2400/858; E05Y 2900/132; G06Q 30/016

(57) ABSTRACT

An inquiry processing device includes: an automatic door information recorder that records information including past inquiry information from a customer regarding an automatic door, an operation situation, and quality information; a countermeasure presenter that presents recommended countermeasure information corresponding to a new inquiry regarding the automatic door by an extraction algorithm; a feedback information receiver that receives feedback information on whether or not a defect of the automatic door has been removed by taking measures on the basis of the recommended countermeasure information; a learner that updates the extraction algorithm of the countermeasure presenter on the basis of the feedback information; and a countermeasure presentation determiner that causes the countermeasure presenter to present new recommended countermeasure information by the extraction algorithm updated by the learner, when it is determined that the defect of the automatic door has not been removed.

### CROSS-REFERENCE TO RELATED APPLICATION

The present application is a continuation application of U.S. patent application Ser. No. 17/132,392 filed on Dec. 23, 2020, the entire contents of which are incorporated herein by reference and priority to which is hereby claimed. Application, Ser. No. 17/132,392 is a continuation under 35 U.S.C. § 120 of PCT/JP2019/030029, filed Jul. 31, 2019, which is incorporated herein reference and which claimed priority to Japanese Patent Application No. 2018-143892, filed Jul. 31, 2018, Japanese Patent Application No. 2018-216849, filed Nov. 19, 2018, and Japanese Patent Application No. 2019-008755, filed Jan. 22, 2019, the disclosures of which are all also incorporated herein by reference.

### BACKGROUND OF THE INVENTION

### 1. Field of the Invention

The present invention relates to an inquiry processing device and an inquiry processing method for processing an inquiry regarding an automatic door.

### 2. Description of the Related Art

An automatic door system opens and closes an automatic door by detecting a person or an object passing the vicinity of an entrance or the like of a building by an automatic door sensor of an infrared system or a radio wave system. In the conventional practice, when a defect occurs in the automatic door, a situation of the defect is generally confirmed from a customer at the time of responding to a telephone inquiry from the customer. However, the customer often does not have sufficient knowledge about the automatic door system. For this reason, it is difficult to correctly confirm the situation of the defect from the customer, and workers are often dispatched to the site even if the customer can easily deal with the defect. However, since dispatching the workers to the site takes time and costs, it takes time to remove the defect of the automatic door, and the customer is burdened with the cost.

Further, in a case of responding to various inquiries from customers at a call center, it is difficult to deploy an operator with abundant knowledge about the automatic door at the call center, in terms of the cost. JP 2004-295396 A discloses a reception processing support device in which a knowledge database is prepared so that even an operator with little specialized knowledge can appropriately respond to inquiries from customers, and when the operator inputs a search keyword to the knowledge database, the knowledge database displays search results in descending order of matching.

Further, J P 2015-17990 A discloses an automatic door sensor in which detection areas are formed on a floor surface through which a person or an object passes, and when the person or the object is detected, a start signal for performing a door opening/closing operation is transmitted to a drive device. The detection areas formed by the automatic door sensor are arranged in a matrix, for example, and each detection area includes a plurality of segments (hereinafter, referred to as the “detection segments”) for detecting the person or the object. Note that the detection segment may be referred to as a detection spot, and in the present specification, the detection segment and the detection spot are used as terms having the same meaning.

### SUMMARY OF THE INVENTION

However, in the automatic door, the frequency of occurrence of a defect or the type of the defect changes due to an operation situation, an environmental condition, or the like, and the situation of the defect also changes due to a model, an installation location, or the like of the automatic door. In JP 2004-295396 A, actually, the inquiries regarding the automatic door are not taken into consideration, and a mechanism for appropriately processing the inquiries from the customers in consideration of the circumstances peculiar to the automatic door is not proposed.

In the automatic door sensor disclosed in JP 2015-17990 A, for example, even if a state in which the door is opened slowly and the person or the object stops in front of the door is generated, it is not possible to obtain information for confirming a situation that causes it. Similarly, in the automatic door sensor, even if a state in which the person or the object contacts the door is generated, it is not possible to obtain information for confirming a situation that causes it.

When the stop state in front of the door or the state of the contact with the door is frequently generated, it is necessary to reset a door drive speed, a detection area, and the like in an automatic door device in order to improve passage efficiency. However, increasing the door drive speed and uniformly expanding the detection area wastefully increase a time for which the door is opened, which results in lowering efficiency of indoor air conditioning. For this reason, it is necessary to reset the door drive speed, the detection area, and the like in the automatic door device after confirming a situation such as an intrusion direction of the person or the object when the stop state or the state of the contact with the door is generated.

Incidentally, an unnecessary opening/closing operation in which the automatic door is opened/closed may be generated even though the person or the object does not pass through the automatic door. The unnecessary opening/closing operation is generated, for example, when the person or the object crosses in front of the automatic door, or when an unexpected disturbance from the outside is applied to the total detection area of the automatic door sensor and the automatic door sensor performs erroneous detection. In the automatic door sensor disclosed in JP 2015-17990 A, when the unnecessary opening/closing operation is generated, it is not possible to provide information for investigating the cause later.

The present invention has been made in view of the above-described problems and provides an inquiry processing device and an inquiry processing method capable of appropriately processing an inquiry from a customer regarding an automatic door.

One aspect of the present invention is an inquiry processing device. The inquiry processing device includes:
an automatic door information recorder that records information including past inquiry information from a customer regarding an automatic door, an operation situation of the automatic door, and quality information of the automatic door,
a countermeasure presenter that presents recommended countermeasure information corresponding to a new inquiry regarding the automatic door by an extraction algorithm for extracting information related to the new inquiry from the past inquiry information from the customer, the operation situation of the automatic door, and the quality information of the automatic door recorded in the automatic door information recorder,
a feedback information receiver that receives feedback information on whether or not a defect of the automatic door has been removed by taking measures on the basis of the recommended countermeasure information,
a learner that updates the extraction algorithm of the countermeasure presenter on the basis of the feedback information; and
a countermeasure presentation determiner that causes the countermeasure presenter to present new recommended countermeasure information by the extraction algorithm updated by the learner, when it is determined that the defect of the automatic door has not been removed on the basis of the feedback information.

Another aspect of the present invention is an inquiry processing method. The inquiry processing method causes a computer to execute:
recording information including past inquiry information from a customer regarding an automatic door, an operation situation of the automatic door, and quality information of the automatic door in an automatic door information recorder,
presenting recommended countermeasure information corresponding to a new inquiry regarding the automatic door by an extraction algorithm for extracting information related to the new inquiry from the past inquiry information from the customer, the operation situation of the automatic door, and the quality information of the automatic door recorded in the automatic door information recorder,
receiving feedback information on whether or not a defect of the automatic door has been removed by taking measures on the basis of the recommended countermeasure information; updating the presented extraction algorithm on the basis of the feedback information; and
presenting new recommended countermeasure information by the updated extraction algorithm, when it is determined that the defect of the automatic door has not been removed on the basis of the feedback information.

### BRIEF DESCRIPTION OF THE DRAWINGS

FIG. 1 is a block diagram showing a schematic configuration of an inquiry processing system including an inquiry processing device according to a first embodiment.

FIG. 2 is a block diagram showing internal configurations of the inquiry processing device and an automatic door system.

FIG. 3 is a diagram showing an effective detection area.

FIG. 4 is a flowchart showing a processing operation of the inquiry processing device when an inquiry regarding the automatic door system is received from a customer.

FIG. 5 is a flowchart showing a processing procedure of troubleshooting by the customer in step S10 of FIG. 4.

FIG. 6 is a flowchart showing a detailed processing operation of customer response processing in a case of not moving in step S22 of FIG. 5.

FIG. 7 is a flowchart showing a detailed processing operation of customer response processing in a case of not being closed in step S24 of FIG. 5.

FIG. 8 is a flowchart showing a detailed processing operation of customer response processing in a case of being opened/closed without permission in step S26 of FIG. 5.

FIG. 9 is a flowchart showing a processing procedure of troubleshooting by a maintenance worker in step S11 of FIG. 4.

FIG. 10 is a flowchart showing a processing operation of an inquiry processing device according to a second embodiment.

FIG. 11 is a flowchart showing a processing operation different from that of FIG. 10 of the inquiry processing device according to the second embodiment.

FIG. 12 is a schematic diagram showing a configuration of an automatic door system including an automatic door sensor according to a third embodiment.

FIG. 13 is a block diagram showing a functional configuration of the automatic door system according to the third embodiment.

FIG. 14 is a schematic diagram showing a detection area on a floor surface of a sensor unit.

FIG. 15 is a chart showing predetermined states that occur in a mobile object,

FIG. 16 is a chart showing a data processing method at the time of storing in a storage.

FIG. 17 is a flowchart showing a procedure of detection information acquisition/storage processing by an information processing device.

FIG. 18 is a chart showing an example of information stored by a data processing unit.

FIG. 19 is a flowchart showing another procedure of the detection information acquisition/storage processing by the information processing device.

FIG. 20 is a chart showing an example of information stored by the data processing unit.

FIG. 21 is a flowchart showing another procedure of the detection information acquisition/storage processing by the information processing device.

FIG. 22 is a chart showing an example of information stored by the data processing unit.

FIG. 23 is a flowchart showing another procedure of the detection information acquisition/storage processing by the information processing device.

FIG. 24 is a chart showing an example of information stored by the data processing unit.

FIG. 25 is a block diagram showing a functional configuration of an automatic door system according to a fourth embodiment.

FIG. 26A and FIG. 26B are schematic diagrams showing partial areas set in a detection area of an automatic door sensor according to a modification,

FIG. 27A and FIG. 27B are schematic diagrams showing partial areas set in a detection area of an automatic door sensor according to another modification.

FIG. 28 is a block diagram showing a functional configuration of an automatic door system according to a fifth embodiment.

FIG. 29 is a schematic diagram showing a detection area on a floor surface of a sensor unit.

FIG. 30 is a flowchart showing a procedure of position identification processing by an information processing device.

FIG. 31 is a chart showing an example of information stored in a storage.

FIG. 32 is a schematic diagram showing an example of distribution by a distribution acquirer.

FIG. 33 is a schematic diagram illustrating an example in which an unnecessary opening/closing operation occurs due to an external factor.

FIG. 34 is a block diagram showing a functional configuration of an automatic door system according to a modification.

### DETAILED DESCRIPTION OF THE INVENTION

The invention will now be described by reference to the preferred embodiments. This does not intend to limit the scope of the present invention, but to exemplify the invention.

Hereinafter, an embodiment of the present disclosure will be described with reference to the drawings. Note that, in the drawings attached to the present specification, scales, aspect ratios, and the like are appropriately changed and exaggerated from those of actual objects for the convenience of illustration and understanding. Further, terms such as “parallel”, “orthogonal”, and “same” identifying shapes and geometric conditions and their degrees, and values of lengths and angles, which are used in the present specification, are interpreted including a range in which similar functions can be expected without being bound by the strict meaning. Further, in the following embodiments, the same components are denoted by the same reference numerals, and redundant description is omitted. Further, in the respective drawings, for convenience of explanation, a part of the components is appropriately omitted.

### First Embodiment

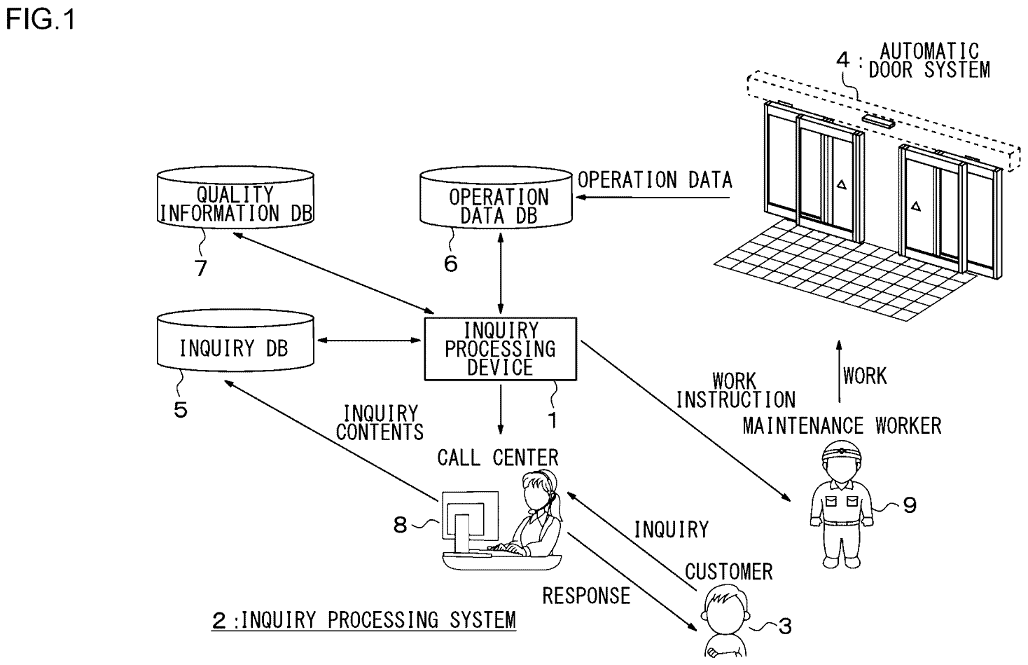

FIG. 1 is a block diagram showing a schematic configuration of an inquiry processing system 2 including an inquiry processing device 1 according to a first embodiment. The inquiry processing device 1 of FIG. 1 is a device that processes an inquiry from a customer 3 regarding an automatic door. In some cases, the inquiry processing device 1 of FIG. 1 may have a function of autonomously performing maintenance and inspection of the automatic door before receiving an inquiry from the customer 3.

The inquiry processing system 2 of FIG. 1 includes the inquiry processing device 1, an automatic door system 4, an inquiry database (DB) 5, an operation data DB 6, a quality information DB 7, and a call center 8. Although one automatic door system 4 is shown in FIG. 1, a plurality of automatic door systems 4 may be provided. The following describes an example of processing an inquiry from the customer 3 who is an owner of one automatic door system 4.

When a defect occurs in the automatic door, the customer 3 who is the owner of the automatic door system 4 inquires of the call center 8 about the defect via a telephone, an e-mail, a facsimile, a website inquiry form, or the like.

An operator of the call center 8 registers inquiry contents of the customer 3 in the inquiry DB 5. At this time, the operator may input the inquiry contents with a keyboard or may convert a voice of the customer 3 into a text by voice recognition, perform syntactic analysis, grammatical analysis, and the like, and register the inquiry contents in the inquiry DB 5. As described above, the operator does not necessarily have to be a person and may be a robot or a computer that performs information processing similar to that of the person.

The inquiry DB 5 is, for example, a database that registers information for identifying each automatic door system 4, an inquiry phenomenon, an occurrence situation, and a customer response result in association with each other, for each automatic door system 4. The information for identifying each automatic door system 4 includes, for example, a customer name, an address, an installation location, identification information of each automatic door when a plurality of automatic doors exists, and the like. The inquiry phenomenon includes that the automatic door does not move, that the automatic door is not closed, that the automatic door is opened/closed without permission, that abnormal noise occurs, and the like The occurrence situation includes the date and time of occurrence of the defect, the frequency of occurrence of the defect, and the like. The customer response result is information indicating what kind of measures have been taken and whether or not the defect has been removed as a result.

The operation data DB 6 is, for example, a database that registers individual management data and operation data in association with each other, for each automatic door system 4. The individual management data includes, for example, various devices configuring the automatic door system 4, a model, a serial number, an installation environment, and an installation time of the automatic door, a mass, a dimension, and a stroke length of the automatic door, and the like. The installation environment is, for example, a cold region, a warm region, a coastal region, or the like. The operation data includes the number of times of opening/closing the automatic door, a total running distance, an energization time, a self-diagnosis error, a set value, a power supply voltage, a motor voltage and current, sensor detection information, a sensor light projecting/receiving amount, an input/output signal, an ambient environment, a data acquisition time, and the like.

The quality information DB 7 is, for example, a database that registers a defect target product, a repair report, and an inspection report, for each automatic door system 4. The defect target product includes, for example, a target product list of the automatic door that has caused the defect, a target machine number, and the like. The repair report includes, for example, information on the automatic door that has been repaired, a phenomenon of the defect, an occurrence situation of the defect, history information of inquiry response results, and the like. The inspection report includes, for example, target opening information and history information of inspection results.

As described in detail later, when the inquiry processing device 1 receives an inquiry from the customer 3, the inquiry processing device 1 searches the inquiry DB 5, the operation data DB 6, and the quality information DB 7 as necessary, and presents recommended countermeasure information corresponding to the inquiry to the operator of the call center 8 and the maintenance worker 9. The operator of the call center 8 transmits the presented recommended countermeasure information to the customer 3 by a telephone or the like. Further, the maintenance worker 9 performs the maintenance work of the automatic door system 4 inquired, according to the presented recommended countermeasure information.

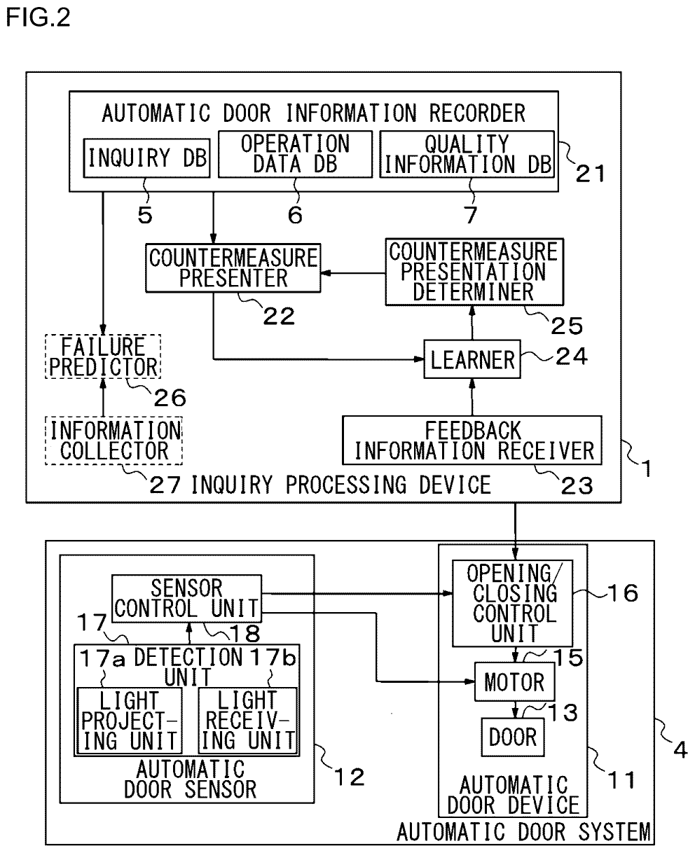

FIG. 2 is a block diagram showing internal configurations of the inquiry processing device 1 and the automatic door system 4. Before explaining the inquiry processing device 1, which is a feature of the present embodiment, the automatic door system 4 will be described. The automatic door system 4 can exchange various information with the inquiry processing device 1. For example, information of the defect that has occurred in the automatic door system 4 may be transmitted to the inquiry processing device 1. For example, if the defect information which the customer 3 does not notice is automatically transmitted from the automatic door system 4 to the inquiry processing device 1, it is possible to take countermeasures against the defect before the inquiry from the customer 3, which results in giving no trouble to the customer 3. Specifically, countermeasure information for the defect found in the inquiry processing device 1 may be transmitted to the automatic door system 4 via a communication line. In this case, when the automatic door system 4 receives the countermeasure information, the automatic door system 4 may automatically execute the countermeasure on the basis of the countermeasure information. As a result, the frequency with which the maintenance worker 9 visits the site can be reduced, and the maintenance cost can be reduced.

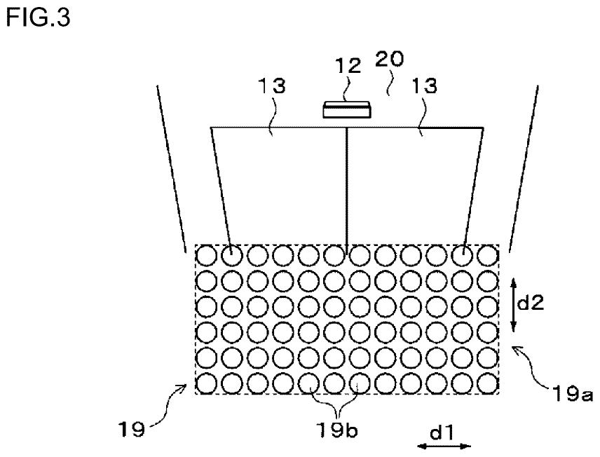

The automatic door system 4 of FIG. 2 has an automatic door device 11 and an automatic door sensor 12. FIG. 3 is a schematic bird's-eye view of the automatic door device 11 and the automatic door sensor 12.

### Automatic Door Device 11

The automatic door device 11 includes a door 13, a motor 15, and an opening/closing control unit 16. The motor 15 is supplied with electric power from a power supply (not shown), and generates a rotational force for automatically opening and closing the door 13. The rotational force of the motor 15 is transmitted to the door 13 as a translational force in an opening/closing direction d1 shown in FIG. 3 via a power transmission member such as a pulley or a timing belt (not shown). In the example of FIG. 3, two doors 13 are sliding doors of a draw type. An aspect of the doors 13 is not limited to the example of FIG. 3, and the doors 13 of various aspects such as a sliding door of a single sliding type, a hinged door, a folding door, and a glide door may be adopted.

The opening/closing control unit 16 is connected to the motor 15 and the automatic door sensor 12. The opening/closing control unit 16 controls the drive of the motor 15 by controlling supplying of the electric power, on the basis of the signals or information acquired from the automatic door sensor 12 and the motor 15. By controlling the drive of the motor 15, the opening/closing control unit 16 controls opening/closing of the door 13. The drive control of the motor 15 is control of at least one of the presence/absence of drive of the motor 15, the drive speed, the drive torque, and the rotation direction, or a combination of two or more thereof.

For example, the opening/closing control unit 16 receives an opening signal according to detection of a pedestrian or an object in an effective detection area 19 described later, from the automatic door sensor 12. The opening/closing control unit 16 performs control to drive the door 13 in an opening direction in response to the input of the opening signal (hereinafter, also referred to as opening drive control).

### Automatic Door Sensor 12

The automatic door sensor 12 detects a detected object in the detection area 19 and performs control to open the door 13. The automatic door sensor 12 is provided above a center of a transom 20 above the door 13, more specifically, above a boundary between the two fully closed doors 13, in order to detect the pedestrian or the like of the door 13. Note that the automatic door sensor 12 may be provided at a location other than the transom 20 (for example, a ceiling of a building).

As shown in FIG. 2, the automatic door sensor 12 includes a detection unit 17 and a sensor control unit 18. The sensor control unit 18 is connected to the detection unit 17.

The sensor control unit 18 is configured by hardware such as a central processing unit (CPU), a read only memory (ROM), and a random access memory (RAM) (not shown), for example. At least a part of the sensor control unit 18 may be configured by software. The detection unit 17 has a light projecting unit 17a and a light receiving unit 17b.

The sensor control unit 18 has an effective detection area 19a. As shown in FIG. 3, the effective detection area 19a is an area of at least a partial range set for detecting a pedestrian or the like of the door 13 in a detection area 19 which is an area on a floor surface that can be detected by using the automatic door sensor 12. The detection area 19 has a rectangular shape extending in a direction d1 parallel to a moving direction of the door 13 and a direction d2 orthogonal to the moving direction of the door 13.

The light projecting unit 17a has a plurality of light projecting elements (not shown). The light projecting unit 17a projects pulsed near-infrared light from each of the plurality of light projecting elements onto the detection area 19, that is, irradiates the detection area 19 with the pulsed near-infrared light. The light receiving unit 17b has a plurality of light receiving elements (not shown) that optically correspond to the plurality of light projecting elements of the light projecting unit 17a. The light receiving unit 17b receives reflected light of the near-infrared light projected onto the detection area 19 from each of the plurality of light projecting elements of the light projecting unit 17a by each of the plurality of light receiving elements and detects a light receiving amount of the reflected light of the near-infrared light for each light receiving element. The light receiving unit 17b outputs the detected light receiving amount to the sensor control unit 18 as a detection signal having a signal value according to the light receiving amount. Note that the light projecting unit 17a and the light receiving unit 17b may project and receive light in a frequency band other than the near-infrared light, that is, electromagnetic waves.

In the example of FIG. 3, the detection area 19 includes a plurality of small detection areas 19b disposed at intervals in an opening/closing direction d1 of the door 13 and a front-back direction d2 orthogonal to the opening/closing direction d1 in front of the two doors 13. In the example of FIG. 3, there are a total of 72 small detection areas 19b of 6 rows×12. Note that the number, size, and specific arrangement of the small detection areas 19b are arbitrary. The small detection area 18b is equivalent to a detection segment and a detection spot.

Each of the small detection areas 19b corresponds to an irradiation spot of the near-infrared light that is projected from each of the plurality of light projecting elements of the light projecting unit 17a and received by each of the plurality of light receiving elements of the light receiving unit 17b.

The effective detection area 19a in the example of FIG. 3 is composed of at least one small detection area 19b among the plurality of small detection areas 19b. Note that, in the example of FIG. 3, each small detection area 19b has a circular shape. A diameter of the small detection area 19b on the floor surface in this case can be set to an arbitrary value between 10 cm and 30 cm, for example. The small detection area 19b may have a shape other than the circular shape such as an elliptical shape, a rectangular shape, or a polygonal shape.

The sensor control unit 18 causes all the light projecting elements of the light projecting unit 17a to project the near-infrared light onto the corresponding small detection areas 19b. Each of all the light receiving elements of the light receiving unit 17b receives the reflected light of the near-infrared light from each small detection area 19b. Then, the sensor control unit 18 extracts the detection signal of the effective detection area 19a from the detection signals of each small detection area 19b input from the light receiving unit 17b. Then, the sensor control unit 18 performs opening/closing control of the door 13 on the basis of the extracted detection signal of the effective detection area 19a.

For example, the sensor control unit 18 may store a signal value (that is, a light receiving amount) of the detection signal of the effective detection area 19a immediately after power supplying of the automatic door system 4 as a reference value, and may detect a detected object such as the pedestrian, on the basis of a change amount of the signal value with respect to the reference value. When the pedestrian in the effective detection area 19a is detected, the sensor control unit 18 outputs an opening signal to the opening/closing control unit 16 of the automatic door device 11 to use a detection result in the effective detection area 19a for opening drive control of the door 13.

### Inquiry Processing Device 1

The inquiry processing device 1 of FIG. 2 includes an automatic door information recorder 21, a countermeasure presenter 22, a feedback information receiver 23, a learner 24, and a countermeasure presentation determiner 25.

The automatic door information recorder 21 records information including past inquiry information from the customer 3 regarding the automatic door 13, an operation situation of the automatic door 13, and quality information of the automatic door 13. The automatic door information recorder 21 has an inquiry DB 5, an operation data DB 6, and a quality information DB 7. The automatic door information recorder 21 may record inquiry information in which information to identify the automatic door 13, inquiry contents, an occurrence situation of an event related to the inquiry contents, and countermeasure information for the inquiry contents are associated with each other. The operation situation recorded in the automatic door information recorder 21 may include at least one of the number of times of opening/closing the automatic door 13, a total running distance, an energization time, self-diagnosis error information, setting information, a power supply voltage, a motor voltage, a motor current, detection sensor information, a light projecting/receiving amount of a detection sensor, an input/output signal, environmental information, and a data acquisition time. The quality information recorded in the automatic door information recorder 21 may include information of a defect of the automatic door 13 that has occurred in the past and information of a repair of the automatic door 13 that has been performed in the past. The automatic door information recorder 21 may record quality information including information identifying a part or a product that has caused the defect, a repair report of the automatic door 13 that has been repaired, and an inspection report of the automatic door 13 that has been inspected.

By an extraction algorithm for extracting information related to a new inquiry regarding the automatic door 13 from the past inquiry information from the customer 3, the operation situation of the automatic door 13, and the quality information of the automatic door 13 recorded in the automatic door information recorder 21, the countermeasure presenter 22 presents recommended countermeasure information corresponding to the new inquiry. The extraction algorithm of the countermeasure presenter 22 may present recommended countermeasure information, on the basis of information extracted by using information on an elapsed time from an installation time of the automatic door 13 for which a new inquiry has been made. The extraction algorithm of the countermeasure presenter 22 may present recommended countermeasure information, on the basis of information extracted by using information on an installation environment of the automatic door 13 for which the new inquiry has been made. The extraction algorithm of the countermeasure presenter 22 may present the countermeasure by the customer 3 as recommended countermeasure information in preference to the countermeasure to be taken by the maintenance worker 9. When there are a plurality of countermeasures corresponding to the new inquiry, the extraction algorithm of the countermeasure presenter 22 may present recommended countermeasure information including information on the priorities of the plurality of countermeasures. When the new inquiry corresponds to at least a part of the operation situation, the countermeasure presenter 22 may present recommended countermeasure information on the basis of the corresponding operation situation. When the new inquiry is related to at least a part of the quality information, the extraction algorithm of the countermeasure presenter 22 may present recommended countermeasure information on the basis of the corresponding quality information.

The feedback information receiver 23 receives feedback information on whether or not the defect of the automatic door 13 has been removed by taking measures on the basis of the recommended countermeasure information. The learner 24 updates the extraction algorithm of the countermeasure presenter 22, on the basis of the feedback information. When it is determined that the defect of the automatic door 13 has not been removed on the basis of the feedback information, the countermeasure presentation determiner 25 causes the countermeasure presenter 22 to present new recommended countermeasure information by the extraction algorithm updated by the learner 24.

The inquiry processing device 1 of FIG. 2 may include a failure predictor 26. The failure predictor 26 predicts a failure of the specific automatic door 13, on the basis of the past inquiry information from the customer 3, the operation situation of the automatic door 13, and the quality information of the automatic door 13 recorded in the automatic door information recorder 21.

The inquiry processing device 1 of FIG. 2 may include an information collector 27 in addition to the failure predictor 26. The information collector 27 collects at least one of the operation situations and the quality information of the specific automatic door 13. The failure predictor 26 may predict the failure of the specific automatic door 13, on the basis of information on a defect that has occurred in an automatic door 13 that shares at least one of a hardware configuration, a software configuration, an installation time, an installation environment, and an operation situation with the specific automatic door 13.

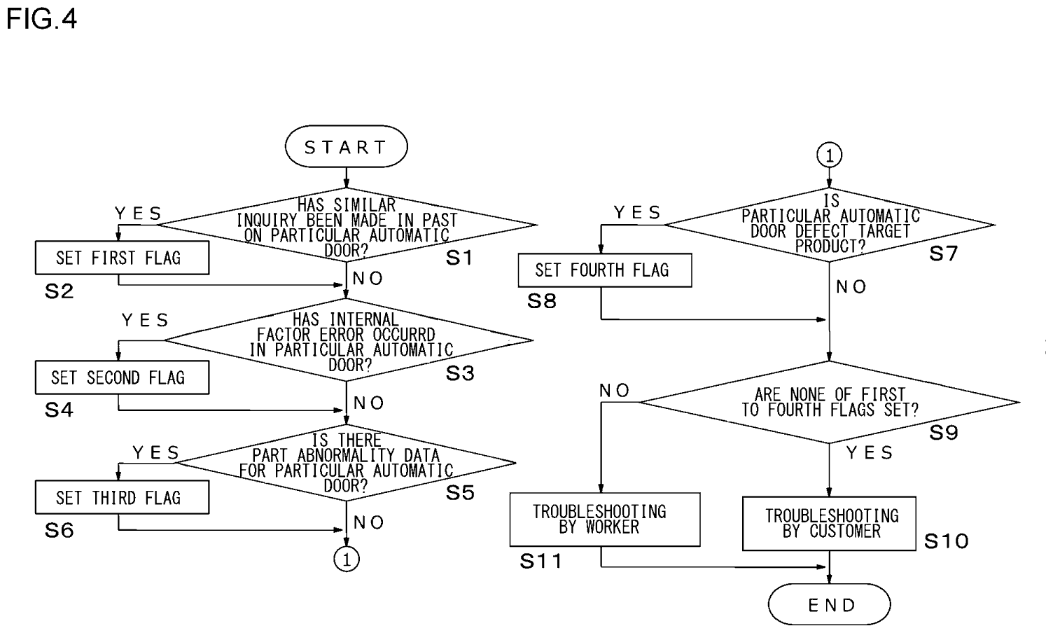

FIG. 4 is a flowchart showing a processing operation of the inquiry processing device 1 when an inquiry regarding the automatic door system 4 is received from the customer 3. First, the countermeasure presenter 22 in the inquiry processing device 1 searches the inquiry DB 5 and determines whether or not a similar inquiry has been made in the past in the automatic door 13 inquired (step S1). When the similar inquiry has been made, a first flag is set (step S2).

When processing of step S2 has been completed or when it is determined in step S1 that the similar inquiry has not been made, the countermeasure presenter 22 determines whether or not an internal factor error has occurred in the automatic door 13 (step S3). In the processing of step S3, the countermeasure presenter 22 searches the operation data DB 6 and confirms whether or not there is the internal factor error. When the internal factor error has occurred, a second flag is set (step S4).

When the processing of step S4 has been completed or when it is determined in step S3 that the internal factor error has not occurred, the countermeasure presenter 22 determines whether or not there is part abnormality data in the automatic door 13 (step S5). In the processing of step S5, the countermeasure presenter 22 searches the operation data DB 6 and confirms whether or not there is the part abnormality data. When there is the part abnormality data, a third flag is set (step S6).

When the processing of step S6 has been completed or when it is determined in step S5 that there is not the part abnormality data, the countermeasure presenter 22 determines whether or not the automatic door 13 is a defect target product (step S7). In the processing of step S7, the countermeasure presenter 22 searches the quality information DB 7 and confirms whether or not the automatic door 13 is the defect target product. When the automatic door 13 is the defect target product, a fourth flag is set (step S8).

When the processing of step S8 has been completed or when it is determined in step S7 that the automatic door 13 is not the defect target product, it is determined whether all the first to fourth flags are not set (step S9). When all the first to fourth flags are not set, the countermeasure presenter 22 presents troubleshooting by the customer 3 (step S10). On the other hand, when at least one of the first to fourth flags is set, troubleshooting by the maintenance worker 9 is presented (step S11).

When all the first to fourth flags are not set, it is considered that there is no abnormality in the automatic door system 4 and that the defect has occurred due to other factors. Therefore, first, processing of troubleshooting by the customer 3 is executed so that the customer 3 can investigate the factor of the defect.

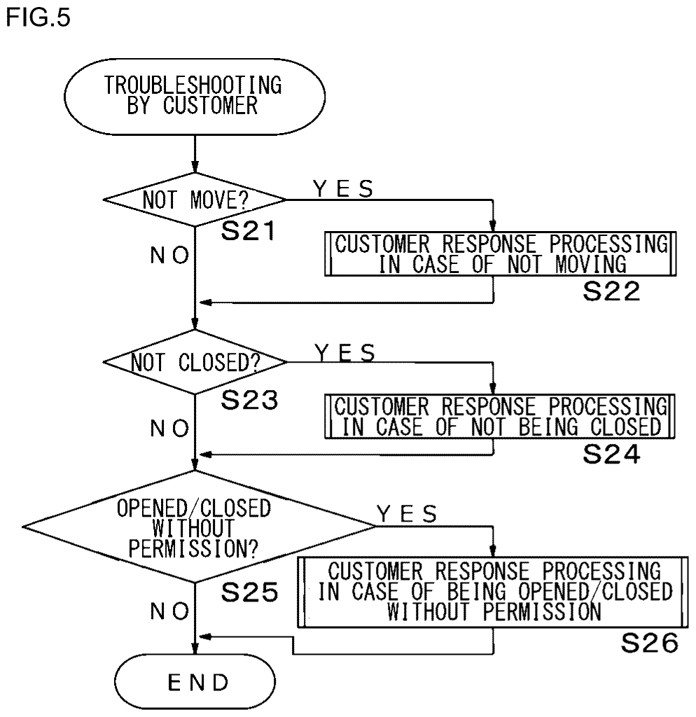

FIG. 5 is a flowchart showing a processing procedure of troubleshooting by the customer 3 in step S10 of FIG. 4. The flowchart is processing performed by the customer 3, and the flowchart may be performed manually by the customer 3 or may be automatically processed by the automatic door system 4 by using a self-diagnosis function built in the automatic door system 4 owned by the customer 3.

First, it is determined whether the automatic door 13 does not move (step S21). In step S21, it may be determined whether the automatic door 13 does not move even if there is a person in the detection area in a state in which power is supplied to the automatic door system 4. When it is determined in step S21 that the automatic door 13 does not move, customer response processing in a case of not moving, which will be described later, is performed (step S22).

When the processing of step S22 has been completed or when it is determined in step S21 that the automatic door 13 moves, it is determined whether the automatic door 13 is not closed (step S23). When it is determined that the automatic door 13 keeps opening and is not closed, customer response processing in a case of not being closed, which will be described later, is performed (step S24).

When the processing of step S24 has been completed or when it is determined in step S23 that the automatic door 13 is closed, it is determined whether or not the automatic door 13 is opened/closed without permission (step S25). When it is determined that the automatic door 13 is opened/closed without permission, customer response processing in a case of being opened/closed without permission, which will be described later, is performed (step S26).

When the processing of step S26 has been completed or when it is determined in step S25 that the automatic door 13 is not opened/closed without permission, the processing of FIG. 5 ends.

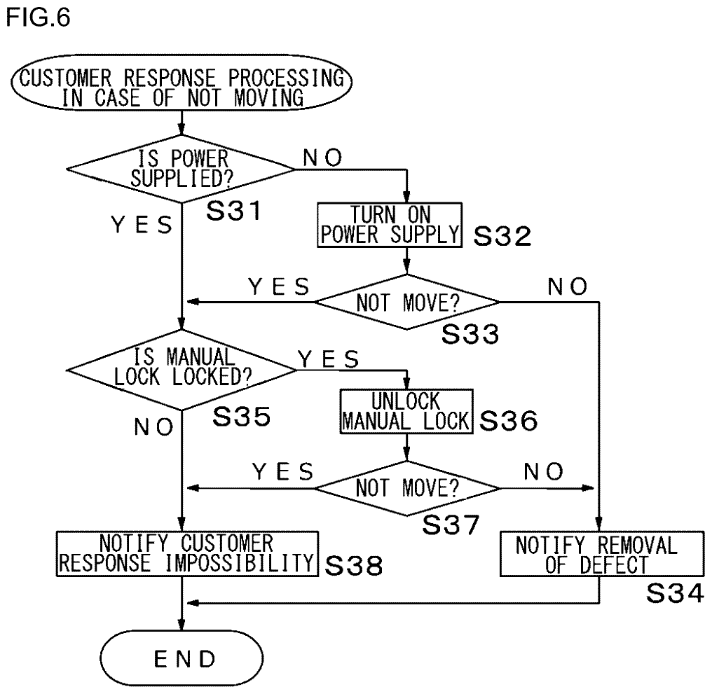

FIG. 6 is a flowchart showing a detailed processing operation of the customer response processing in a case of not moving in step S22 of FIG. 5. First, it is determined whether or not power is supplied to the automatic door system 4 (step S31). When the power is not supplied, the power is supplied (step S32). Then, it is determined again whether or not the automatic door 13 does not move (step S33). When the automatic door 13 moves, the call center 8 is notified that the defect has been removed (step S34), and the processing of FIG. 6 ends.

When it is determined in step S33 that the automatic door 13 does not move or when it is determined in step S31 that the power is supplied, it is determined whether or not a manual lock provided in the automatic door 13 is locked (step S35). When the manual lock is locked, the manual lock is unlocked (step S36). Then, it is determined again whether the automatic door 13 does not move (step S37). When the automatic door 13 moves, the processing of step S34 is performed, and then the processing of FIG. 6 ends.

When it is determined in step S35 that the manual lock is not locked or when it is determined in step S37 that the automatic door 13 does not move, the call center 8 is notified that the customer response is impossible (step S38). The operator of the call center 8 that has received the notification again registers in the inquiry DB 5 that the automatic door 13 has not moved even if the customer response processing is performed. The inquiry processing device 1 presents new countermeasure information by searching the inquiry DB 5, the operation data DB 6, and the quality information DB 7 for the registered information.

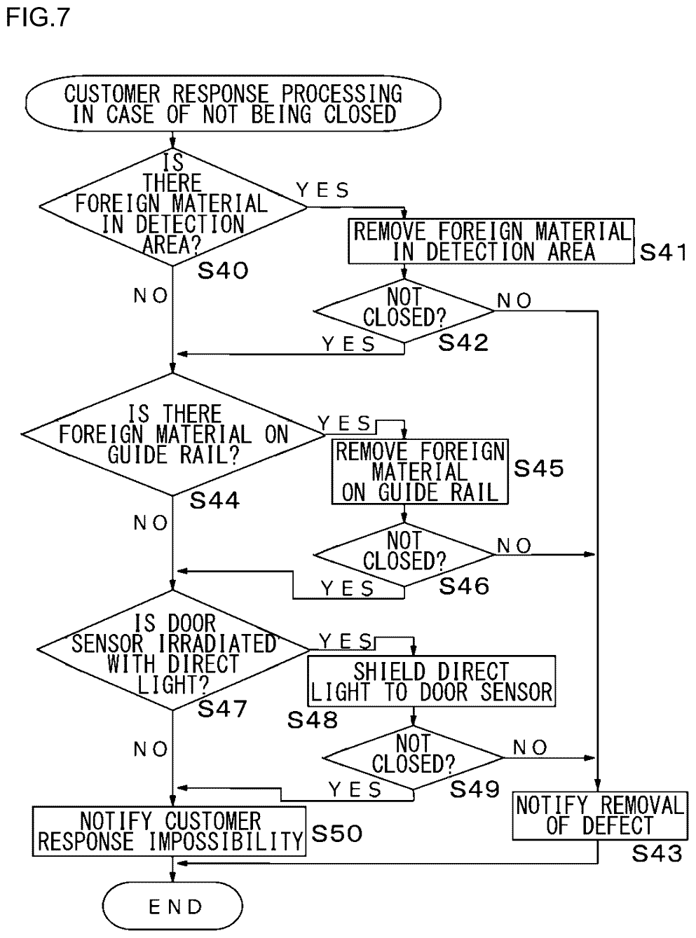

FIG. 7 is a flowchart showing a detailed processing operation of the customer response processing in a case of not being closed in step S24 of FIG. 5. First, it is determined whether or not there is a foreign material in the detection area (step S40). Here, the foreign material refers to a detected object that causes the automatic door sensor 12 to erroneously open the automatic door 13. When there is the foreign material, the foreign material in the detection area is removed (step S41). Then, it is determined again whether the automatic door 13 is not closed (step S42). When the automatic door 13 is closed, the call center 8 is notified that the defect has been removed (step S43), and the processing of FIG. 7 ends.

When it is determined in step S40 that there is not the foreign material in the detection area or when it is determined in step S42 that the door 13 is not closed, it is determined whether the automatic door 13 cannot move in the closing direction due to the foreign material on a guide rail that is a movement path of the automatic door 13 (step S44). When there is the foreign material on the guide rail, the foreign material is removed (step S45). Then, it is determined again whether the automatic door 13 is not closed (step S46). When the automatic door 13 is closed, the processing of step S43 is performed, and then the processing of FIG. 7 ends.

When it is determined in step S44 that there is not the foreign material on the guide rail or when it is determined in step S46 that the automatic door 13 is not closed, it is determined whether or not the automatic door sensor 12 is irradiated with direct light such as sunlight (step S47). When the automatic door sensor 12 is irradiated with the direct light, the direct light to the automatic door sensor 12 is shielded (step S48). Then, it is determined whether or not the automatic door 13 is closed (step S49). When the automatic door 13 is closed, the processing of step S43 is performed, and then the processing of FIG. 7 ends.

When it is determined in step S47 that the automatic door sensor 12 is not irradiated with the direct light or when it is determined in step S49 that the automatic door 13 is not closed, the inquiry processing device 1 is notified that the customer response is impossible (step S50), and the processing of FIG. 7 ends.

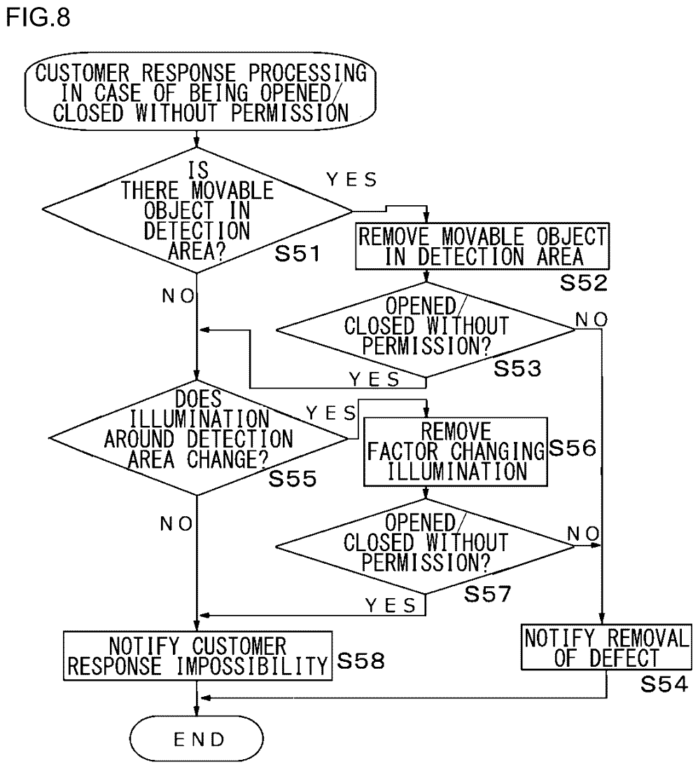

FIG. 8 is a flowchart showing a detailed processing operation of the customer response processing in a case of being opened/closed without permission in step S26 of FIG. 5. First, it is determined whether or not there is a movable object in the detection area (step S51). The movable object may be an animal including a person or a vehicle. When the movable object enters or leaves the detection area, the automatic door 13 is repeatedly opened and closed. Therefore, in step S51, it is confirmed whether or not there is the movable object. When there is the movable object in the detection area, the movable object is removed (step S52). Then, it is determined again whether or not the automatic door 13 is opened/closed without permission (step S53). When the automatic door 13 is not opened/closed without permission, the call center 8 is notified that the defect has been removed (step S54), and the processing of FIG. 8 ends.

When it is determined in step S51 that there is not the movable object in the detection area or when it is determined in step S53 that the automatic door 13 is opened/closed without permission, it is determined whether or not the illumination intensity around the detection area changes regularly or irregularly (step S55). When the illumination intensity around the detection area changes, the automatic door sensor 12 may erroneously determine that the detected object exists or does not exist in the detection area. Therefore, when the illumination intensity in the detection area changes, a factor that changes the illumination intensity is removed (step S56). For example, when there is a blinking light source around the detection area, it is conceivable to turn off the light source. Then, it is determined again whether or not the automatic door 13 is opened/closed without permission (step S57). When the automatic door 13 is not opened/closed without permission, the processing of step S54 is performed, and then the processing of FIG. 8 ends.

When it is determined in step S55 that the illumination intensity does not change or when it is determined in step S57 that the automatic door 13 is opened/closed without permission, the call center 8 is notified that the customer response is impossible (step S58), and the processing of FIG. 8 ends.

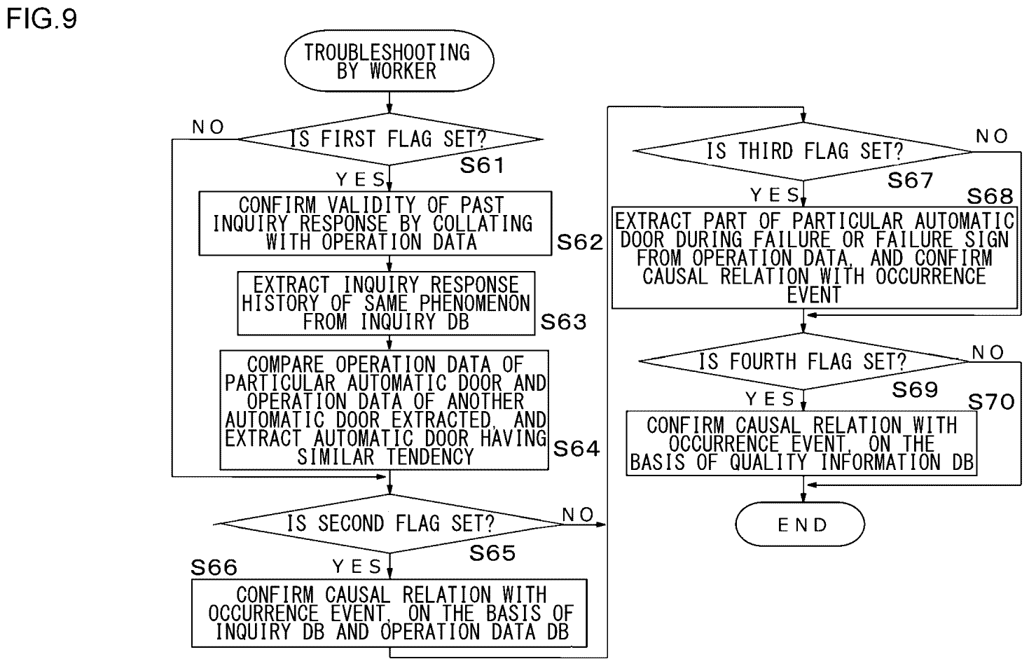

FIG. 9 is a flowchart showing a processing procedure of troubleshooting by the maintenance worker 9 in step S11 of FIG. 4. The flowchart of FIG. 9 includes an extraction algorithm for extracting information related to a new inquiry regarding the automatic door 13 from the past inquiry information from the customer 3, the operation situation of the automatic door 13, and the quality information of the automatic door 13 recorded in the automatic door information recorder 21, and processing of receiving feedback information on whether or not the defect of the automatic door 13 has been removed by taking measures on the basis of recommended countermeasure information presented by the extraction algorithm and updating the extraction algorithm. Although the processing of FIG. 9 can be executed by the inquiry processing device 1, at least a part of the processing of FIG. 9 may be manually executed by the maintenance worker 9.

First, it is determined whether or not a first flag indicating that an inquiry similar to this inquiry has been received in the past is set (step S61). When the first flag is set, the inquiry DB 5 and the operation data DB 6 are searched and the validity of the past inquiry response is confirmed by collating with the operation data (step S62). When it is determined that there is the validity, the inquiry processing device 1 presents the recommended countermeasure information based on the past inquiry response to the maintenance worker 9. This presentation is made through the call center 8. When the maintenance worker 9 possesses a mobile terminal such as a tablet, a PC, a smartphone, or a mobile phone, the recommended countermeasure information may be transmitted to the mobile terminal via a communication line. Alternatively, the operator of the call center 8 may voice the recommended countermeasure information to the maintenance worker 9 via a telephone line. The maintenance worker 9 performs the maintenance work of the automatic door 13 inquired, according to the recommended countermeasure information. Further, the maintenance worker 9 collects feedback information indicating whether or not the defect has been removed as a result of performing the maintenance work, and transmits the feedback information to the inquiry processing device 1. The feedback information may be transmitted from the automatic door system 4 to the inquiry processing device 1 via the communication line, or the maintenance worker 9 may visually confirm the feedback information and transmit the feedback information to the call center 8 by a telephone or the like. When the feedback information is received, the call center 8 registers the feedback information in the inquiry DB 5. Then, the inquiry processing device 1 updates the above-described extraction algorithm on the basis of the registration information of the inquiry DB 5. The updated extraction algorithm is re-registered in the inquiry DB 5.

Next, an inquiry response history regarding the defect of the same phenomenon as this inquiry from the customer 3 is extracted from the inquiry DB 5 (step S63). Next, the operation data of the automatic door 13 is compared with the operation data of another automatic door 13 extracted in step S63, and the automatic door 13 having a similar tendency is extracted (step S64). The inquiry processing device 1 instructs the maintenance worker 9 in charge of the automatic door 13 to inspect the automatic door 13 extracted in step S64, so that it is possible to perform a desired maintenance work before the automatic door 13 causes the defect. As a result, the frequency of occurrence of the defect of the automatic door system 4 can be reduced.

When the processing of step S64 has been completed or when it is determined in step S61 that the first flag is not set, it is determined whether or not a second flag indicating that an internal factor error has occurred is set (step S65). When the second flag is set, a causal relation with an occurrence event is confirmed on the basis of the inquiry DB 5 and the operation data DB 6 (step S66). As a result, when a cause of the internal factor error can be identified, the maintenance worker 9 executes the maintenance work on the basis of recommended countermeasure information for removing the internal factor error. Then, the maintenance worker 9 collects feedback information on whether or not the defect of the automatic door 13 has been removed, and transmits the feedback information to the inquiry processing device 1. When the feedback information is received, the inquiry processing device 1 updates the extraction algorithm including the recommended countermeasure information for the internal factor error.

When the processing of step S66 has been completed or when it is determined in step S65 that the second flag is not set, it is determined whether or not a third flag indicating that there is part abnormality data is set (step S67). When the third flag is set, the operation data DB 6 is searched, a part of the automatic door 13 during the failure or the failure sign is extracted from the operation data, and a causal relation with the occurrence event is confirmed (step S68). When the maintenance worker 9 determines that it is necessary to replace or repair the part on the basis of the confirmation in step S68, the maintenance worker 9 replaces or repairs the part. The maintenance worker 9 collects feedback information indicating whether or not the defect has been removed by replacing or repairing the part and transmits the feedback information to the inquiry processing device 1. When the feedback information is received, the inquiry processing device 1 updates the extraction algorithm including the recommended countermeasure information for the part abnormality data.

When the processing of step S68 has been completed or when it is determined in step S67 that the third flag is not set, it is determined whether or not the fourth flag indicating that the automatic door is the defect target product is set (step S69). When the fourth flag is set, the causal relation with the occurrence event is confirmed on the basis of the quality information DB 7 (step S70). When the maintenance worker 9 searches the quality information DB 7 and finds that the automatic door is the defect target product as a result thereof, the maintenance worker 9 performs the maintenance work on the basis of the information registered in the quality information DB 7. When the processing of step S70 has been completed or when it is determined in step S69 that the fourth flag is not set, the processing of FIG. 9 ends.

As described above, in the first embodiment, the recommended countermeasure information is presented on the basis of the extraction algorithm in response to the inquiry from the customer 3 regarding the automatic door 13, the feedback information on whether or not the defect of the automatic door 13 has been removed on the basis of the presented recommended countermeasure information is received, and the extraction algorithm is updated. Therefore, by continuously repeating inquiries regarding many automatic door systems 4 and updating of recommended countermeasure information, various inquiries from the customer 3 can be processed quickly and accurately. As a result, most of the inquiry processing that is conventionally performed manually can be automated, and a service to the customer 3 can be improved while maintenance costs are reduced.

### Second Embodiment

An inquiry processing system 2 including an inquiry processing device 1 according to a second embodiment has block configurations similar to those in FIG. 1 to FIG. 3. However, the inquiry processing system 2 according to the second embodiment is different from that in the first embodiment in an extraction algorithm of recommended countermeasure information for an inquiry regarding an automatic door 13.

When there is an inquiry regarding the automatic door 13 from a customer 3, the inquiry processing device 1 according to the second embodiment changes the extraction algorithm for extracting the recommended countermeasure information by an elapsed time from the installation of an automatic door system 4

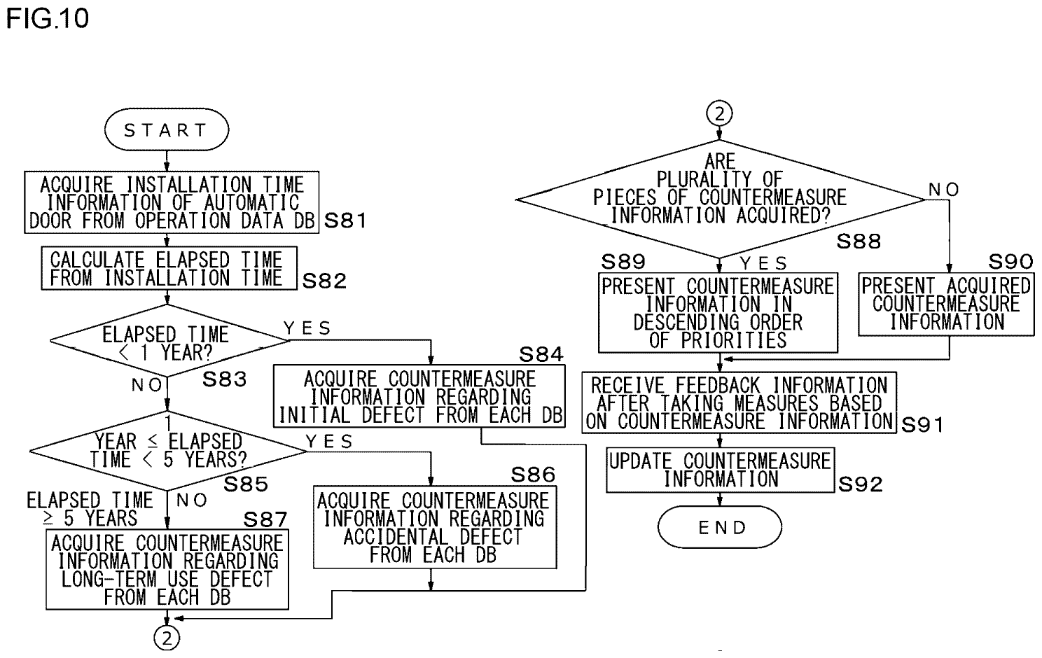

FIG. 10 is a flowchart showing a processing operation of the inquiry processing device 1 according to the second embodiment, and mainly shows processing of a countermeasure presenter 22. The processing of the flowchart of FIG. 10 is started when there is an inquiry regarding the automatic door 13 from the customer 3. First, installation time information of the automatic door system 4 is acquired from an operation data DB 6 (step S81).

Next, the elapsed time from the installation time is calculated (step S82). It is determined whether or not the elapsed time is less than one year (step S83). When the elapsed time is less than one year, recommended countermeasure information on an initial defect is generated on the basis of at least one of an inquiry DB 5, an operation data DB 6, and a quality information DB 7 (step S84). The recommended countermeasure information on the initial defect is countermeasure information on a defect that often occurs immediately after the installation of the automatic door system 4. For example, when some parts in the automatic door system 4 cause the initial defect and the automatic door 13 does not operate normally, the parts are replaced.

When it is determined in step S83 that the elapsed time is not less than one year, it is determined whether the elapsed time is one year or more and less than five years (step S85). When the elapsed time is one year or more and less than the five years, recommended countermeasure information on an accidental defect is generated on the basis of at least one of the inquiry DB 5, the operation data DB 6, and the quality information DB 7 (step S86). The accidental defect is a case where the automatic door 13 does not operate normally due to a temporary variation in the power supply voltage, a case where some parts are damaged by lightning, or the like. In this case, it is conceivable to investigate a factor of the variation in the power supply voltage to confirm whether or not the normal power supply voltage is restored, or to replace the parts damaged by lightning or the like.

When it is determined in step S85 that the elapsed time is not one year or more and less than the five years, it is determined that the elapsed time is the five years or more, and recommended countermeasure information on a long-term use defect is generated on the basis of at least one of the inquiry DB 5, the operation data DB 6, and the quality information DB 7 (step S87). The long-term use defect is, for example, a case where some parts in the automatic door system 4 do not perform an original operation due to aged deterioration. In this case, it is conceivable to replace some parts.

When the processing of step S84, S86, or S87 is completed, it is determined in step S84, S86, or S87 described above whether or not a plurality of pieces of recommended countermeasure information have been generated (step S88). When the plurality of pieces of recommended countermeasure information have been generated, the recommended countermeasure information is presented in descending order of priorities (step S89). When it is determined in step S88 that only a piece of recommended countermeasure information has been generated, this recommended countermeasure information is presented (step S90).

When the processing of step S89 or S90 is completed, feedback information indicating a result of performing a maintenance work of the automatic door 13 by the maintenance worker 9 on the basis of the presented recommended countermeasure information is received (step S91). Next, countermeasure information in at least one of the inquiry DB 5, the operation data DB 6, and the quality information DB 7 is updated on the basis of the received feedback information (step S92).

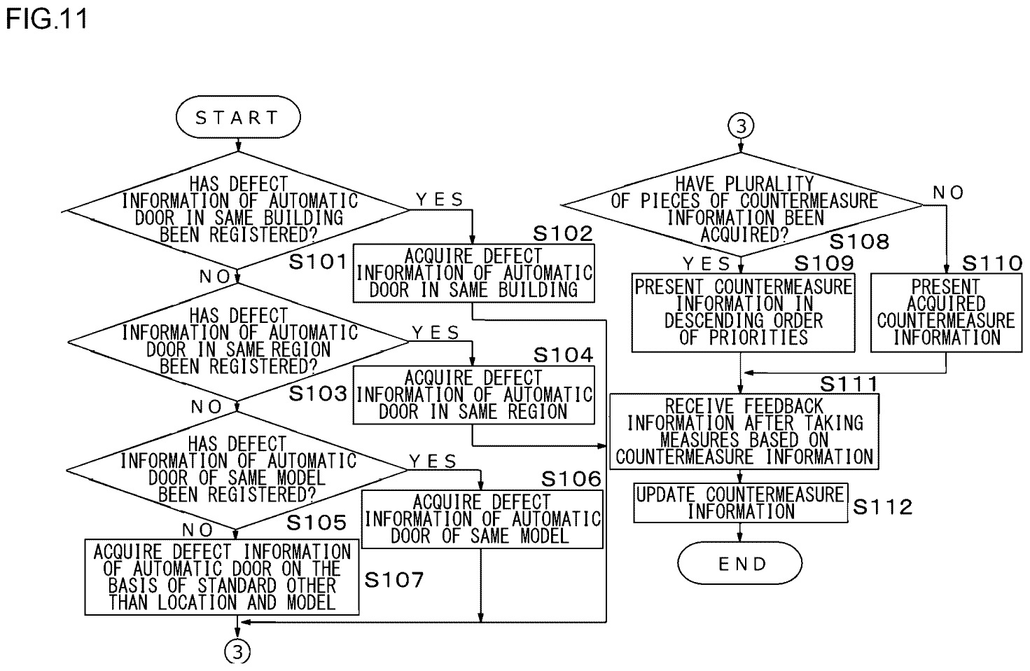

Further, the inquiry processing device 1 may change recommended countermeasure information according to an installation location, a model, and the like of the automatic door system 4. FIG. 11 is a flowchart showing a processing operation different from that of FIG. 10 of the inquiry processing device 1 according to the second embodiment. First, it is determined whether or not defect information of the automatic door 13 in the same building has been registered in at least one of the inquiry DB 5, the operation data DB 6, and the quality information DB 7 (step S101). When the defect information has been registered, the defect information of the automatic door 13 in the same building is acquired (step S102). The reason why the defect information of the automatic door 13 in the same building is acquired is that, when there are a plurality of automatic door systems 4 in the same building and each automatic door system 4 is supplied with power from the same power supply device, similar defects may occur due to a variation in the power supply voltage. Further, since environmental conditions such as temperature and humidity are also almost the same in the same building, similar defects may occur due to the environmental conditions.

When it is determined in step S101 that the defect information of the automatic door 13 in the same building has not been registered, it is determined whether or not defect information of the automatic door 13 in the same region has been registered in at least one of the inquiry DB 5, the operation data DB 6, and the quality information DB 7 (step S103). When the defect information has been registered, the defect information of the automatic door 13 in the same region is acquired (step S104). The reason why the defect information of the automatic door 13 in the same region is acquired is that a substation is often commonly used in the same region, and when the power supply voltage supplied from the substation varies, all automatic door systems 4 in the same region are affected by the variation. Further, since environmental conditions such as temperature and humidity are almost the same in the same region, similar defects may occur due to the environmental conditions.

When it is determined in step S103 that the defect information of the automatic door 13 in the same region has not been registered, it is determined whether or not defect information of the automatic door 13 of the same model has been registered in at least one of the inquiry DB 5, the operation data DB 6, and the quality information DB 7 (step S105). When the defect information has been registered, the defect information of the automatic door 13 of the same model is acquired (step S106). The reason why the defect information of the automatic door 13 of the same model is acquired is that it is reported that the automatic doors 13 of some models often cause defects under certain conditions, and when model-dependent defect information is registered in at least one of the inquiry DB 5, the operation data DB 6, and the quality information DB 7, it is desirable to acquire the registration information and take countermeasures.

When it is determined in step S105 that the defect information of the automatic door 13 of the same model has not been registered, the defect information of the automatic door 13 is acquired on the basis of a standard other than the location and the model (step S107). Here, although the specific content of the standard is arbitrary, the specific content may be a manufacturer of the automatic door 13 or parts used in the automatic door 13.

When step S107 is completed, processing similar to that in steps S88 to S92 of FIG. 10 is performed (steps S108 to S112).

As described above, in the second embodiment, since the extraction algorithm for extracting the recommended countermeasure information is changed according to the elapsed time from the installation time of the automatic door 13, the installation location, or the model of the automatic door 13, an extraction algorithm that conforms with an actual situation can be generated, and optimal countermeasure information for defects can be presented.

At least a part of the inquiry processing device 1 described in the above embodiment may be configured by hardware or software. When at least a part of the inquiry processing device 1 is configured by software, a program that realizes at least a part of the functions of the inquiry processing device 1 may be stored in a recording medium such as a flexible disk or a CD-ROM, read by a computer, and executed. The recording medium is not limited to a removable medium such as a magnetic disk or an optical disk and may be a fixed recording medium such as a hard disk device or a memory.

Further, the program that realizes at least a part of the functions of the inquiry processing device 1 may be distributed via a communication line (including wireless communication) such as the Internet. Further, in a state in which the program is encrypted, modulated, or compressed, the program may be distributed via a wired line or a wireless line such as the Internet or in a form of being stored in a recording medium.

### Third Embodiment

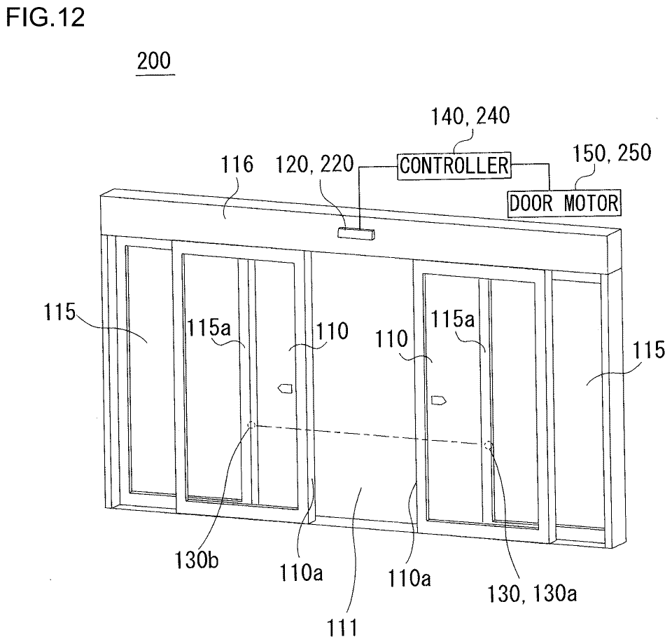

FIG. 12 is a schematic diagram showing a configuration of an automatic door system 200 including an automatic door sensor 120 according to a third embodiment. The automatic door system 200 has doors 110, an automatic door sensor 120, an auxiliary photoelectric sensor 130, a controller 140, and the like. The automatic door system 200 shown in FIG. 12 is a double-sliding door type, and the two doors 110 are automatically opened and closed to the left and right. The doors 110 that are a pair of left and right doors can be reciprocated along fixtures 115 fixedly disposed with a space on the left and right, and open and close an opening 111 between the left and right fixtures 115. Note that the door 110 corresponds to the automatic door of the present invention.

The doors 110 are in a fully closed state when the opening 111 is closed by contacting the left and right door end stiles 110a so as to be abutted against each other. The doors 110 are in a fully opened state when the door end stiles 110a move to be separated from each other, the door end stiles 110a move to the vicinity of mullions 115a of the fixtures 115 and stop, and the opening 111 is opened. Note that the automatic door system 200 may be a single-sliding door type and a revolving door type, in addition to the double-sliding door type.

The automatic door sensor 120 is, for example, disposed in a transom 116 above the opening 111, and projects and receives infrared light obliquely downward from the arrangement position in the transom 116, detects a mobile object such as a pedestrian or an object entering the door 110, and outputs a start signal to the controller 140. The details of the automatic door sensor 120 will be described later. Note that, in the following description, the mobile object is used as a term for a person or an object.

The auxiliary photoelectric sensor 130 is a detection device using a photoelectric system and has a light projector 130a and a light receiver 130b disposed on the mullions 115a of the fixtures 115. The auxiliary photoelectric sensor 130 detects that a light beam passing between the light projector 130a and the light receiver 130b is shielded, and outputs detection information indicating that the mobile object exists on a track of the door 110 to the controller 140. Note that the auxiliary photoelectric sensor 130 may be a detection device using a light reflection system or an ultrasonic system attached to the transom 116, in addition to the photoelectric system.

When the controller 140 receives the start signal from the automatic door sensor 120, the controller 140 operates a door motor 150 and drives the door 110 until the door 110 is fully opened. After the door 110 is fully opened, the controller 140 holds the fully opened state for a constant period of time and operates the door motor 150 in a reverse direction to drive the door 110 until the door 110 is fully closed. When the controller 140 receives the detection information from the auxiliary photoelectric sensor 130 while the door 110 is closed, the controller 140 reverses a drive direction of the door 110 by the door motor 150 and causes the door 110 to be in the fully opened state.

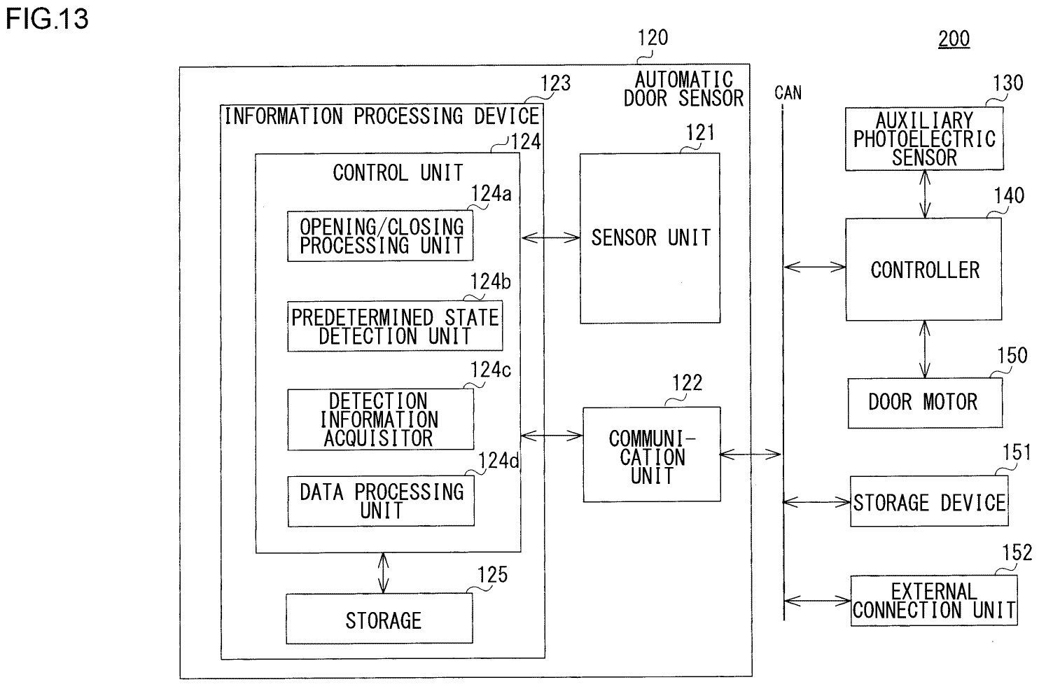

FIG. 13 is a block diagram showing a functional configuration of the automatic door system 200 according to the third embodiment. Each block can be realized by electronic elements including a CPU of a computer and mechanical parts in terms of hardware and can be realized by a computer program and the like in terms of software. However, here, the functional blocks realized by their cooperation are drawn. Therefore, those skilled in the art will understand that these functional blocks can be realized in various forms by combining hardware and software.

The automatic door sensor 120, the controller 140, and a storage device 151 are connected to be able to communicate with each other by a controller area network (CAN). The communication connection between the automatic door sensor 120, the controller 140, and the storage device 151 is not limited to CAN, and wireless communication such as WiFi (registered trademark) may be used.

The automatic door sensor 120 includes a sensor unit 121 as a detection element, a communication unit 122, and an information processing device 123. The communication unit 122 exchanges data between the controller 140 and the storage device 151. The sensor unit 121 is an infrared reflection type sensor and includes a light projector that projects infrared rays onto a detection area described later and a light receiver that receives reflected light from a mobile object or the like.

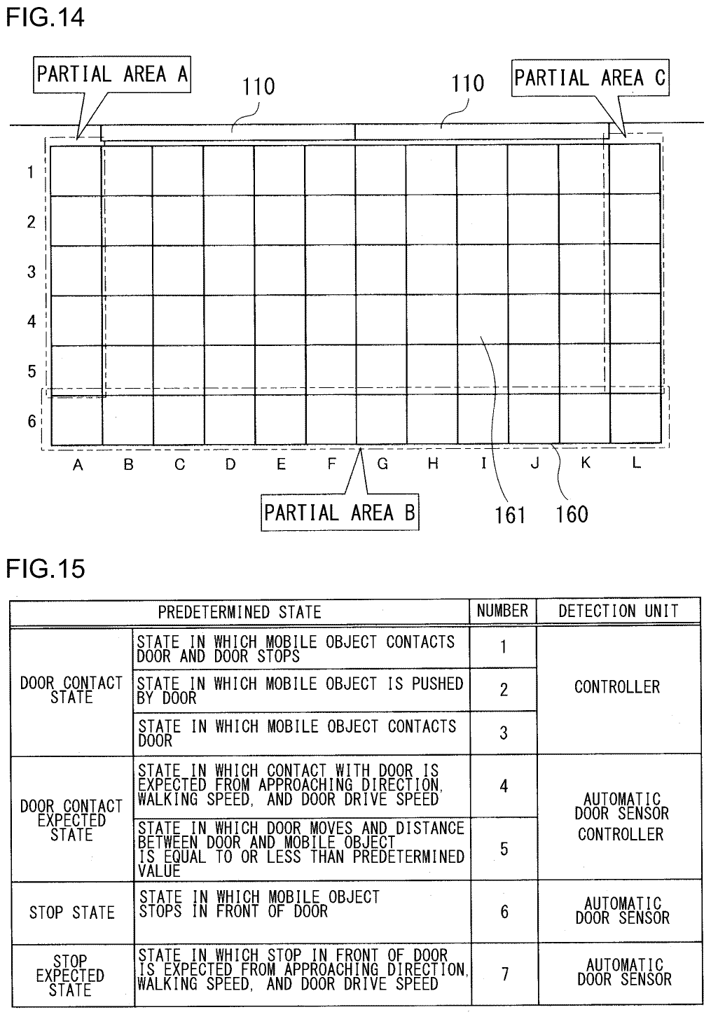

FIG. 14 is a schematic diagram showing a detection area 160 on a floor surface of the sensor unit 121. The detection area 160 is provided to detect a mobile object around the door 110 and open/close the door 110. The detection area 160 has a three-dimensional range extending from the floor surface to the transom 116 on which the automatic door sensor 120 is disposed or the ceiling. The detection area 160 includes a plurality of detection spots 161 in which 12 rows are arranged in a direction parallel to a moving direction of the door 110 and 6 rows are arranged in a direction orthogonal to the moving direction of the door 110. Addresses 1A, 1B, . . . , 6K, and 6L corresponding to positions of the arrangement are assigned to the detection spots 161, respectively. Note that a shape of each detection spot 161 and a shape of the entire detection area 160 may be a polygonal shape other than a circular shape, an elliptical shape, and a rectangular shape. Further, the sensor unit 121 may be a radio wave type sensor, an ultrasonic type sensor, a laser scan type sensor, or an image type sensor.

One or more detection spots 161 located in a peripheral portion of the detection area 160 are grouped, and partial areas are set as subdivision of the detection area 160. By setting the partial areas in the peripheral portion of the detection area 160, it is possible to grasp in which direction the set partial areas are located with respect to the door 110. In the example shown in FIG. 14, five detection spots 161 at addresses 1A, 2A, 3A, 4A, and 5A are grouped as a partial area A. In addition, 12 detection spots 161 at addresses 6A, 6B, . . . , and 6L are grouped as a partial area B, and 5 detection spots 161 at addresses 1L, 2L, 3L, 4L, and 5L are grouped as a partial area C. The partial areas A to C are located in the peripheral portion of the detection area 160 as shown in FIG. 14. Further, by setting the partial area in the vicinity of the door 110 in the detection area 160 and detecting the mobile object in the partial area, it may be determined whether or not the mobile object has come close to the door 110, and it may be assumptively determined that the mobile object has passed through the door 110. In this case, 10 detection spots 161 in the vicinity of the door 110 such as addresses 1B, 1C, 1D, . . . , and 1K shown in FIG. 14 may be grouped and set as the partial area.

The partial area A of the detection area 160 forms a subdivisional area for detecting the mobile object entering the door 110 from a leftward direction toward the door 110. Similarly, the partial area C of the detection area 160 forms a subdivisional area for detecting the mobile object entering the door 110 from a rightward direction toward the door 110. Further, the partial area B of the detection area 160 forms a subdivisional area for detecting the mobile object entering the door 110 from a front direction toward the door 110.

Even when the shape of the detection area 160 is a polygonal shape other than a circular shape, an elliptical shape, and a rectangular shape, the partial areas extending in the leftward direction, the rightward direction, and the front direction toward the door 110 may be defined in the peripheral portion of the detection area 160, and one or more detection spots 161 in the defined partial areas may be grouped.

The partial area set in the peripheral portion of the detection area 160 may not be provided so as to envelop the peripheral portion of the detection area 160 by a plurality of partial areas. In this case, in the peripheral portion of the detection area 160, a portion where the partial area is not set is recognized as an unset area in which the partial area is not set in the peripheral portion of the detection area 160 (hereinafter, referred to as the unset area). Further, only one partial area may be provided in the peripheral portion of the detection area 160, and a portion in the peripheral portion of the detection area 160 that is not included in the partial area may be set as the unset area. For example, when only the partial area A shown in FIG. 14 is provided, the partial area B and the partial area C are recognized as the unset areas in the peripheral portion of the detection area 160.

Returning to FIG. 13, the information processing device 123 of the automatic door sensor 120 has a control unit 124 and a storage 125. The storage 125 is a storage device configured using, for example, a solid state drive (SSD), a hard disk, a CD-ROM, a DVD, or the like. The control unit 124 has an opening/closing processing unit 124a, a predetermined state detection unit 124b, a detection information acquirer 124c, and a data processing unit 124d. The opening/closing processing unit 124a generates a start signal for opening the door 110 according to a detection result of each detection spot 161, and outputs the start signal to the controller 140 via the communication unit 122. The inquiry processing device 1 described on the basis of FIG. 2 may be configured to include the information processing device 123 excluding the opening/closing processing unit 124a. Further, the inquiry processing device 1 may be considered to be configured as a system in which the information processing device 123 excluding the opening/closing processing unit 124a is provided in the automatic door sensor 120 and the information processing device 123 is included.

The opening/closing processing unit 124a monitors a detection level of infrared light corresponding to each detection spot 161 of the sensor unit 121 and compares a first threshold lower than a detection level when there is not the mobile object in the detection spot 161 and a second threshold higher than a light receiving level to determine whether or not there is the mobile object. The opening/closing processing unit 124a sequentially acquires the detection level at each detection spot 161 from the sensor unit 121, and when the detection level is equal to or less than the first threshold or equal to or more than the second threshold, the opening/closing processing unit 124a determines that there is the mobile object and generates a start signal. Further, the opening/closing processing unit 124a outputs the address of the detection spot 161 whose detection level is equal to or less than the first threshold or equal to or more than the second threshold to the detection information acquirer 124c as detection information.

Further, the detection information output by the opening/closing processing unit 124a is output when the mobile object is detected in each set partial area, and the address of the detection spot 161 whose detection level is equal to or less than the first threshold or equal to or more than the second threshold is output to the detection information acquirer 124c as detection information. The detection information output by the opening/closing processing unit 124a may be information of the address of the detection spot 161 or information indicating in which of the respective partial areas the mobile object has been detected. Further, as described above, when there is the unset area in which the partial area is not set in the peripheral portion of the detection area 160, the detection information may be information indicating that the mobile object has been detected in the unset area. In this case, the opening/closing processing unit 124a determines which partial area or unset area includes the detection spot 161 whose detection level is equal to or less than the first threshold or equal to or more than the second threshold, and then outputs information for identifying the partial area or the unset area including the detection spot 161 as the detection information. When the partial areas A to C are set as described above, the opening/closing processing unit 124a may determine, for example, a code corresponding to each partial area, and may output a code corresponding to the partial area including the detection spot 161 in which the mobile object has been detected to the detection information acquirer 124c. Further, when there is the unset area, a code corresponding to the unset area may be determined, and the code may be output to the detection information acquirer 124c. Note that, when the mobile object is not detected in the partial areas A to C and the unset area, the opening/closing processing unit 124a outputs a code indicating non-detection to the detection information acquirer 124c.

Further, the opening/closing processing unit 124a may output all information indicating whether or not the mobile object has been detected in all the detection spots 161 of the detection area 160 for each of all the detection spots 161. The detection information output from the opening/closing processing unit 124a to the detection information acquirer 124c is not limited to the form described here.

The predetermined state detection unit 124b detects predetermined states caused by low passage efficiency of the mobile object that has entered the door 110. FIG. 15 is a chart showing predetermined states that occur in the mobile object. The predetermined states include a door contact state in which the mobile object contacts the door 110, a door contact expected state in which a contact with the door 110 is expected, a stop state in which the mobile object stops in front of the door 110, and a stop expected state when the mobile object is expected to stop in front of the door 110.

The door contact state can be divided into three states. That is, the door contact state includes a state in which the mobile object contacts the door 110 and the door 110 stops, a state in which the mobile object contacts the door 110 and is pushed by the door 110, and a state in which the mobile object contacts the door 110. The state in which the mobile object contacts the door 110 and the door 110 stops is detected when a drive load of the door 110 exceeds an allowable value and the door 110 is stopped in the controller 140. The state in which the mobile object contacts the door 110 and is pushed by the door 110 is detected when the drive load of the door 110 is increased in the controller 140. Further, the state in which the mobile object contacts the door 110 is detected when the drive load of the door 110 is slightly increased in the controller 140, although not as much as the state in which the mobile object is pushed by the door 110.

The door contact expected state includes a state in which a contact with the door 110 is expected on the basis of an approaching direction, a walking speed, and a door drive speed, and a state in which the door 110 moves and a distance between the door 110 and the mobile object is a predetermined value or less (for example, 30 cm or less). The state in which the contact with the door 110 is expected on the basis of the approaching direction, the walking speed, and the door drive speed is detected when an opening width of the door 110 based on the door drive speed is a predetermined value or less (for example, 20 cm or less), at a door arrival time of the mobile object calculated on the basis of the approaching direction and the walking speed of the mobile object obtained by a transition of a detection situation of the detection spots 161 in the automatic door sensor 120, for example. The state in which the door 110 moves and the distance between the door 110 and the mobile object is the predetermined value or less is detected by a position of the detection spot 161 where the mobile object is detected in the automatic door sensor 120.

Further, in addition to the states shown in FIG. 15, a state in which the mobile object is detected on the track of the door 110 by the auxiliary photoelectric sensor 130 while the door 110 moves in the closing direction is considered to be included in the door contact expected state. This state is detected by the drive information in the controller 140 and the detection information by the auxiliary photoelectric sensor 130.

The stop state is detected when the detection level at the detection spot 161 in the automatic door sensor 120 maintains a level at which the presence of the mobile object is detected for a predetermined time (for example, 2 seconds or more). Further, the stop state is detected when the opening width of the door 110 is a predetermined value or less (for example, 10 cm or less) at the time of detecting the mobile object at the detection spots 161 (for example, detection spots at addresses 1B, 1C, . . . , and 1K shown in FIG. 14) in the vicinity of the door 110 in the detection area 160. The stop expected state is detected when the opening width of the door 110 is within a predetermined range (for example, more than 20 cm and equal to or less than 40 cm), at a door arrival time of the mobile object calculated on the basis of the approaching direction and the walking speed of the mobile object obtained by the transition of the detection situation of the detection spots 161 in the automatic door sensor 120, for example.

As shown in FIG. 15, the predetermined states are identified by numbers 1 to 7 assigned corresponding to the above-described predetermined states. The predetermined state detection unit 124b may detect all the predetermined states of the numbers 1 to 7, or may detect one or more predetermined states. When it is determined that the predetermined state of each of the numbers 1 to 7 occurs on the basis of the detection situation in the automatic door sensor 120 and the drive situation (situation such as the drive load or the stop) in the controller 140, the predetermined state detection unit 124b outputs the number of the corresponding predetermined state to the data processing unit 124d.

The detection information acquirer 124c acquires the detection information in the partial areas A to C as the operation situation of the door 110, and integrates the number of times the detection information has been acquired for each of the partial areas A to C. For example, when the address of the detection spot 161 input from the opening/closing processing unit 124a is an address included in the partial area A, the detection information acquirer 124c acquires detection information indicating that the presence of the mobile object in the partial area A has been detected. The detection information acquirer 124c holds the acquired detection information, and sequentially updates the detection information on the basis of the address of the detection spot 161 input from the opening/closing processing unit 124a. For example, when the address of the detection spot 161 input from the opening/closing processing unit 124a is an address included in the partial area B (or C), the detection information acquirer 124c updates the detection information with detection information indicating that the presence of the mobile object in the partial area B (or C) has been detected. Further, as described above, when there is an unset area in which a partial area is not set in the peripheral portion of the detection area 160, the detection information acquirer 124c updates the detection information with detection information indicating that the presence of the mobile object in the unset area has been detected. When the address of the detection spot 161 input from the opening/closing processing unit 124a is an address not included in the partial areas A to C or the unset area, the detection information acquirer 124c holds the currently held detection information.

The detection information acquirer 124c acquires the number of times the mobile object has passed for each of the partial areas A to C by integrating the number of times the detection information has been acquired for each of the partial areas A to C. When the address of the detection spot 161 input from the opening/closing processing unit 124a is included in the partial area A, for example, and then the address of the detection spot 161 input from the opening/closing processing unit 124a is not included in the partial area A, the detection information acquirer 124c integrates the number of time the detection information of the partial area A has been acquired by one. The detection information acquirer 124c performs the same integration processing on the partial areas B and C, and acquires the number of times the mobile object has passed for each of the partial areas A to C by integrating the number of times the detection information has been acquired for each of the partial areas A to C.

Further, the detection information acquirer 124c may sequentially acquire information indicating that the mobile object has been detected in any of the partial areas A to C or the unset area from the opening/closing processing unit 124a and may update the information as the detection information. Even in this case, the detection information acquirer 124c acquires the number of times the mobile object has passed for each of the partial areas A to C by integrating the number of times the detection information has been acquired for each of the partial areas A to C. The detection information acquirer 124c acquires a code indicating non-detection in which the mobile object is not detected in the partial areas A to C and the unset area from the opening/closing processing unit 124a, and integrates the number of times the detection information has been acquired for each of the partial areas A to C.

Further, the detection information acquirer 124c may acquire all information indicating whether or not the mobile object has been detected at all the detection spots 161 of the detection area 160 from the opening/closing processing unit 124a for all the detection spot 161 and may acquire the detection information in the partial areas A to C or the unset area. The detection information acquirer 124c acquires the detection information in the partial areas A to C or the unset area, on the basis of the information indicating whether or not the mobile object has been detected at all the detection spots 161. For example, when it is determined that the address of the detection spot 161 where the mobile object has been detected is an address included in the partial area A, on the basis of the information input from the opening/closing processing unit 124a, the detection information acquirer 124c acquires detection information indicating that the presence of the mobile object in the partial area A has been detected. The detection information acquirer 124c may sequentially determine whether or not the address of the detection spot 161 where the mobile object has been detected is an address included in the partial areas A to C or the unset area, on the basis of the information input from the opening/closing processing unit 124a and may update the detection information. Further, the detection information acquirer 124c acquires the number of times the mobile object has passed for each of the partial areas A to C by integrating the number of times the detection information has been acquired for each of the partial areas A to C.

When the number of the predetermined state is input from the predetermined state detection unit 124b, the data processing unit 124d requests the detection information acquirer 124c to output the currently held detection information and acquires the detection information. The data processing unit 124d stores, in the storage 125, occurrence of an event that the detection information acquirer 124c has acquired the detection information in the set partial areas A to C when the mobile object is in the predetermined state, on the basis of the detection information acquired from the detection information acquirer 124c. Further, the data processing unit 124d acquires date and time information from a timer (not shown) and stores it in the storage 125 as additional information.

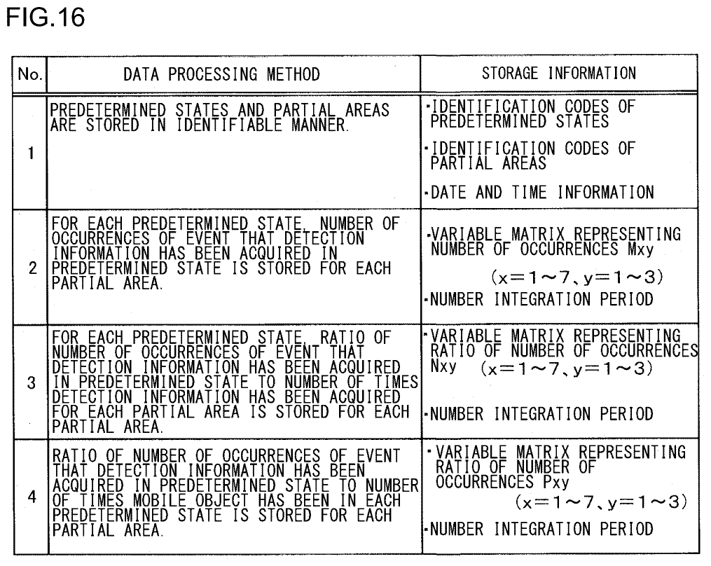

FIG. 16 is a chart showing a data processing method at the time of storing in the storage 125. In a data processing method No. 1, the data processing unit 124d stores the predetermined states and the partial areas indicated by the detection information acquired from the detection information acquirer 124c, in an identifiable manner. For example, 3-bit codes corresponding to the numbers 1 to 7 of the predetermined states and 2-bit codes corresponding to the partial areas A to C are generated and stored in the storage 125 together with the date and time.

In a data processing method No. 2, the data processing unit 124d integrates the number of occurrences of an event that the detection information has been acquired for each of the partial areas A to C with respect to each predetermined state, on the basis of the detection information acquired from the detection information acquirer 124c, and stores it together with integrated period information (integration start date and time and the like). For example, a variable matrix Mxy (x=1 to 7 and y=1 to 3) corresponding to the numbers 1 to 7 of the predetermined states and the partial areas A to C is created and stored in the storage 125, and each time the predetermined state occurs, elements of the variable matrix Mxy are identified, 1 is added, and the elements are stored in the storage 125.

In a data processing method No. 3, the data processing unit 124d acquires the number of times the detection information acquirer 124c has acquired the detection information for each of the partial areas A to C, from the detection information acquirer 124c. The data processing unit 124d integrates the number of occurrences of an event that the detection information has acquired for each of the partial areas A to C when the mobile object is in the predetermined state, on the basis of the detection information acquired from the detection information acquirer 124c. The data processing unit 124d calculates a ratio of the number of occurrences of the event for each of the partial areas A to C to the number of times the detection information has been acquired for each of the partial areas A to C and stores it together with calculated period information (calculation start date and time and the like). For example, a variable matrix Nxy (x=1 to 7 and y=1 to 3) corresponding to the numbers 1 to 7 of the predetermined states and the partial areas A to C is created and stored in the storage 125. It is assumed that each element of the variable matrix Nxy is calculated as a ratio of the number of occurrences of the event for each of the partial areas A to C with respect to each of the predetermined states (x=1 to 7) to the number of times Ny (y=1 to 3) the detection information has been acquired for each of the partial areas A to C. Each time the predetermined state occurs, the elements of the variable matrix Nxy are identified, and the ratio is recalculated. Therefore, it is necessary to store the number of times Ny the detection information has been acquired for each of the partial areas A to C in the storage 125 as a parameter.

In a data processing method No. 4, the data processing unit 124d calculates a ratio of the number of occurrences of an event that the detection information has been acquired occurs for each of the partial areas A to C to the number of times the mobile object has been in each predetermined state, and stores the ratio together with the number of times the mobile object has been in each predetermined state and the calculated period information (calculation start date and time and the like). For example, a variable matrix Pxy (x=1 to 7 and y=1 to 3) corresponding to the numbers 1 to 7 of the predetermined states and the partial areas A to C is created and stored in the storage 125. It is assumed that each element of the variable matrix Pxy is calculated as a ratio to the number of times Px (x=1 to 7) the mobile object has been in each predetermined state. Each time the predetermined state occurs, the elements of the variable matrix Pxy are identified, and the ratio is recalculated. Therefore, it is necessary to store the number of times Px the mobile object has been in each predetermined state in the storage 125 as a parameter.

The data processing unit 124d may store the stored information according to the data processing methods Nos. 1 to 4 in the storage device 151 (see FIG. 13) connected via CAN instead of the storage 125. The storage device 151 is a storage device configured using, for example, a recording tape type data logger, a solid state drive (SSD), a hard disk, a CD-ROM, a DVD, or the like, and obtains information from other components or devices connected so as to be able to communicate with each other by CAN and stores the information. The information stored in the storage 125 or the like by the data processing unit 124d can be read from a mobile terminal or a PC via an external connection unit 152.

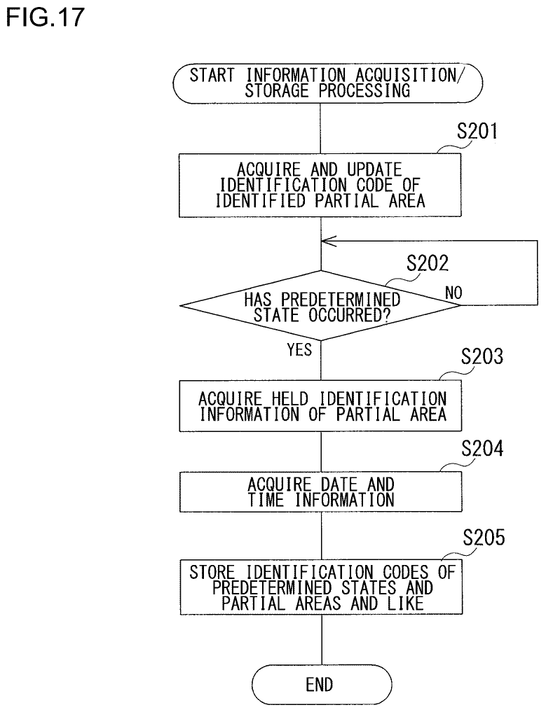

Next, the operation of the automatic door system 200 according to the third embodiment will be described on the basis of detection information acquisition/storage processing by the information processing device 123 of the automatic door sensor 120. FIG. 17 is a flowchart showing a procedure of the detection information acquisition/storage processing by the information processing device 123. The procedure of the detection information acquisition/storage processing shown in FIG. 17 is based on the data processing method No. 1 shown in FIG. 16.

The detection information acquirer 124c of the information processing device 123 identifies the partial areas A to C including the address of the detection spot 161 input from the opening/closing processing unit 124a. The detection information acquirer 124c acquires an identification code of the identified partial area as the detection information indicating that the presence of the mobile object in the partial area has been detected. The detection information acquirer 124c sequentially acquires and updates the identification code of the partial area identified on the basis of the address of the detection spot 161 input from the opening/closing processing unit 124a (S201). Even when information other than the address of the detection spot 161 is input from the opening/closing processing unit 124a, the detection information acquirer 124c can acquire and update the identification code of the partial area identified on the basis of the input information. This is also applied to processing based on the data processing methods No. 2 to No. 4 described later.

When it is determined that the predetermined state of each of the numbers 1 to 7 occurs on the basis of the detection situation in the automatic door sensor 120 and the drive situation (situation such as the drive load or the stop) in the controller 140, the predetermined state detection unit 124b outputs the number of the corresponding predetermined state to the data processing unit 124d. The data processing unit 124d determines whether or not the predetermined state has occurred (S202). The data processing unit 124d determines that the predetermined state has occurred when there is an input from the predetermined state detection unit 124b (S202: YES) and requests the detection information acquirer 124c to output the held identification code of the partial area and acquires the identification code (S203). The data processing unit 124d acquires date and time information from a timer (S204), stores the identification codes corresponding to the predetermined states of the numbers 1 to 7, the identification codes of the partial areas, and the date and time information in the storage 125 (S205), and ends the processing. In step S202, when there is no input from the predetermined state detection unit 124b, the data processing unit 124d determines that the predetermined state has not occurred (S202: NO) and repeats the determination in step S202.

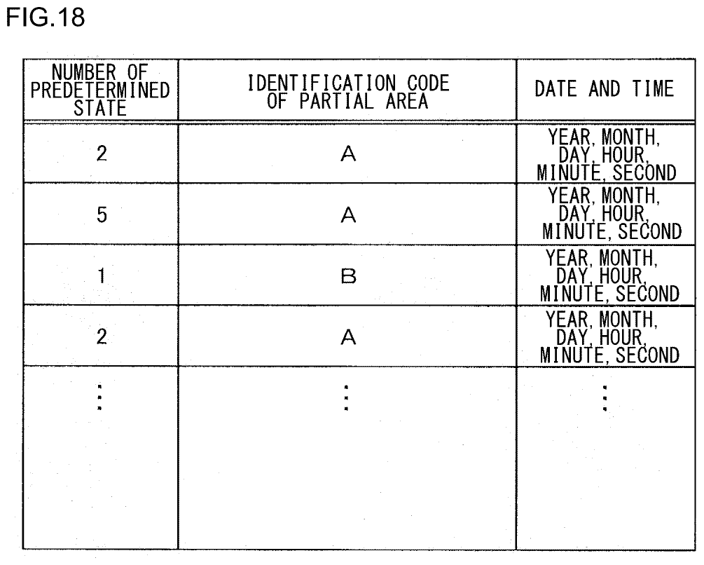

The data processing unit 124d repeats the processing of steps S201 to S205 shown in FIG. 17, so that information on the predetermined states that occur every moment is stored in the storage 125. FIG. 18 is a chart showing an example of information stored by the data processing unit 124d. The stored information shown in FIG. 18 is read by a mobile terminal or a PC via the external connection unit 152, and it is possible to efficiently confirm whether or not the predetermined state occurs when the mobile object enters from any of the partial areas A to C.

For example, when the mobile object enters from the partial area A of the partial areas A to C, on the basis of the information read by the mobile terminal or PC, it is analyzed that the predetermined state of No. 2 frequently occurs, so that resetting for expanding the detection area 160 toward the side of the partial area A in the detection area 160, that is, the door 110 in a leftward direction can be taken as a countermeasure. Further, for example, when it is analyzed that the predetermined state occurs in a case where the mobile object enters the entire partial areas A to C, it is possible to take countermeasures to expand the detection area 160 in the leftward and rightward directions and the front direction as a whole, or to change setting to setting for increasing the drive speed of the door 110. Further, it is analyzed which of the door contact state and the door contact expected state frequently occurs as tendency, or which of the stop state and the stop expected state frequently occurs as tendency, so that it is also possible to set a degree to which the detection area 160 is expanded and a degree to which the drive speed of the door 110 is increased. When the door contact state or the stop state frequency occurs, the degree to which the detection area 160 is expanded and the degree to which the drive speed of the door 110 is increased can be increased, and when the door contact expected state or the stop expected state frequently occurs, the degrees can be decreased.

The data processing unit 124d may store the identification information of the predetermined states and the partial areas in the storage 125 once or a plurality of times. Even if the information stored in the storage 125 is only information for one occurrence of the predetermined state, it is possible to take countermeasures to improve passage efficiency with reference to the information.

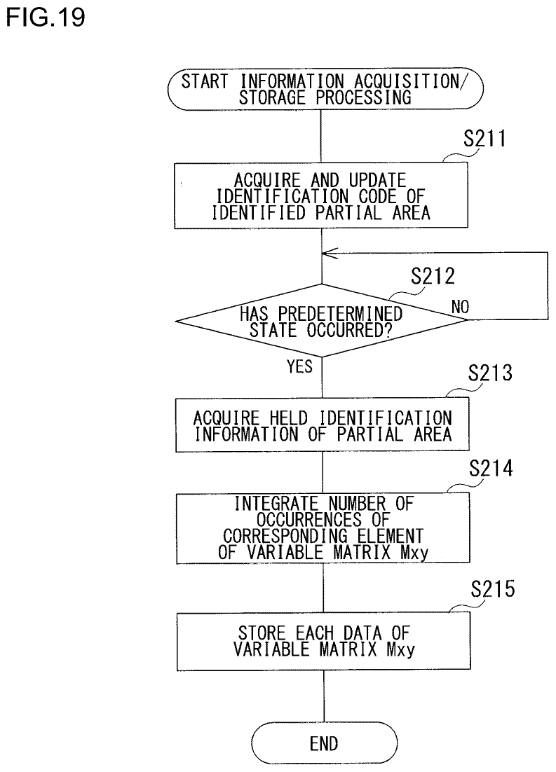

FIG. 19 is a flowchart showing another procedure of the detection information acquisition/storage processing by the information processing device 123. The procedure of the detection information acquisition/storage processing shown in FIG. 19 is based on the data processing method No. 2 shown in FIG. 16. At the start of the processing, the data processing unit 124d first acquires information on the start date and time from the timer and stores it in the storage 125.

Similarly to step S201 shown in FIG. 17, the detection information acquirer 124c of the information processing device 123 sequentially acquires and updates the identification code of the partial area identified on the basis of the address of the detection spot 161 input from the opening/closing processing unit 124a (S211).

Further, similarly to step S202 shown in FIG. 17, the data processing unit 124d determines whether or not the predetermined state has occurred (S212). The data processing unit 124d determines that the predetermined state has occurred when there is an input from the predetermined state detection unit 124b (S212: YES) and requests the detection information acquirer 124c to output the held identification code of the partial area and acquires the identification code (S213). The data processing unit 124d adds 1 to the element corresponding to the identification code of the partial area and the identification code of the predetermined state among the elements of the variable matrix Mxy and integrates the number of occurrences (S214). Each data of the variable matrix Mxy is stored in the storage 125 (S215), and the processing ends. In step S212, when there is no input from the predetermined state detection unit 124b, the data processing unit 124d determines that the predetermined state has not occurred (S212: NO) and repeats the determination in step S212.

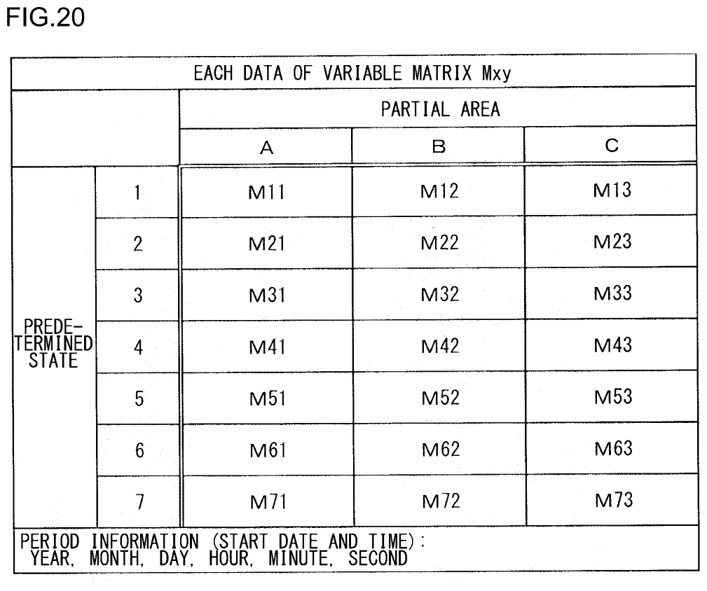

By repeating the processing of steps S211 to S215 shown in FIG. 19 by the data processing unit 124d, for each of the predetermined states of the numbers 1 to 7, the number of occurrences of an event that the detection information has been acquired when the mobile object is in the predetermined state can be stored for each of the partial areas A to C. FIG. 20 is a chart showing an example of information stored by the data processing unit 124d. The stored information shown in FIG. 20 is read by a mobile terminal or a PC via the external connection unit 152, it is possible to efficiently confirm whether or not each predetermined state frequently occurs when the mobile object enters from any of the partial areas A to C, and it is possible to take countermeasures.

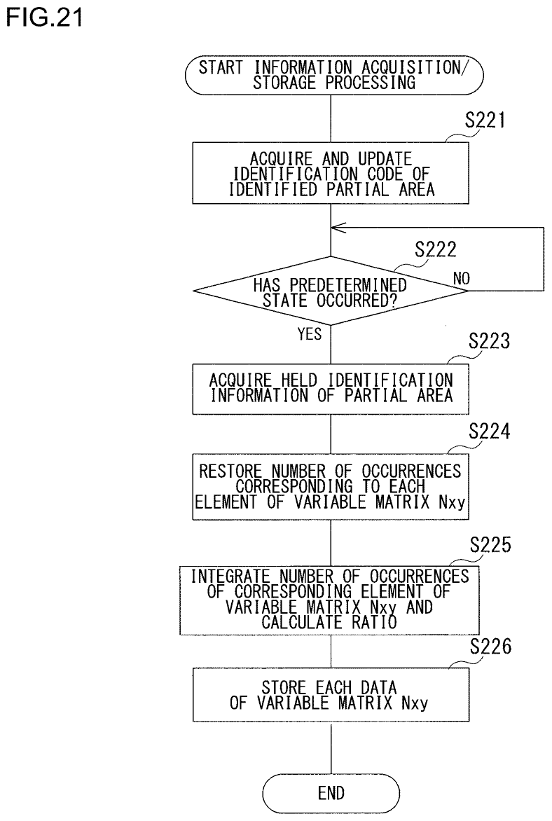

FIG. 21 is a flowchart showing another procedure of the detection information acquisition/storage processing by the information processing device 123. The procedure of the detection information acquisition/storage processing shown in FIG. 21 is based on the data processing method No. 3 shown in FIG. 16. At the start of the processing, the data processing unit 124d first acquires information on the start date and time from the timer and stores it in the storage 125.

Similarly to step S201 shown in FIG. 17, the detection information acquirer 124c of the information processing device 123 sequentially acquires and updates the identification code of the partial area identified on the basis of the address of the detection spot 161 input from the opening/closing processing unit 124a (S221).

Further, similarly to step S202 shown in FIG. 17, the data processing unit 124d determines whether or not the predetermined state has occurred (S222). The data processing unit 124d determines that the predetermined state has occurred when there is an input from the predetermined state detection unit 124b (S222: YES) and requests the detection information acquirer 124c to output the held identification code of the partial area and acquires the identification code (S223). The data processing unit 124d restores the number of occurrences corresponding to each element by using the number of times Ny the detection information has been acquired for each of the partial areas A to C from the elements (representing the ratio) of the variable matrix Nxy (S224). The data processing unit 124d adds 1 to the elements corresponding to the identification code of the partial area and the identification code of the predetermined state, integrates the number of occurrences, and calculates a ratio of the number of occurrences of each element to the number of times Ny the detection information has been acquired for each of the partial areas A to C (S225). Note that, for the number of times Ny the detection information has been acquired for each of the partial areas A to C, the data processing unit 124d uses Ny stored at the time of restoration in step S224. At the time of calculating the ratio in step S224, the data processing unit 124d acquires the number of times Ny the detection information has been acquired for each of the partial areas A to C at the time of calculation, from the detection information acquirer 124c, uses it, and stores it in the storage 125. The data processing unit 124d stores each data of the variable matrix Nxy in the storage 125 (S226) and ends the processing. In step S222, when there is no input from the predetermined state detection unit 124b, the data processing unit 124d determines that the predetermined state has not occurred (S222: NO) and repeats the determination in step S222.

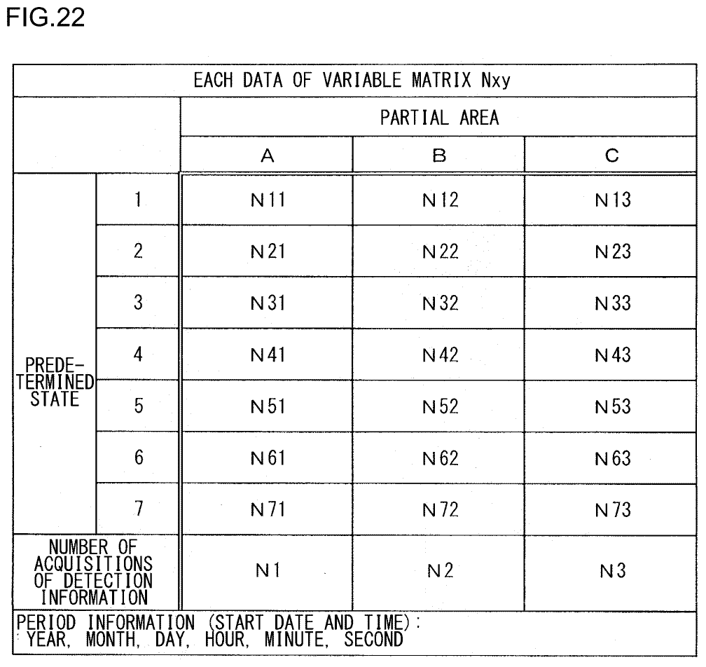

By repeating the processing of steps S221 to S226 shown in FIG. 21 by the data processing unit 124d, for each of the predetermined states of the numbers 1 to 7, the number of occurrences of an event that the detection information has been acquired for each of the partial areas A to C when the mobile object is in the predetermined state can be stored as a ratio to the number of times the detection information has been acquired for each of the partial areas A to C. FIG. 22 is a chart showing an example of information stored by the data processing unit 124d. The stored information shown in FIG. 22 is read by a mobile terminal or a PC via the external connection unit 152, it is possible to efficiently confirm whether or not each predetermined state frequently occurs when the mobile object enters from any of the partial areas A to C, and it is possible to take countermeasures. Since the information stored in the storage 125 by the data processing unit 124d is data of the ratio for each element of the variable matrix Nxy, a numerical value does not increase due to integration, and the capacity required as the storage area can be reduced.

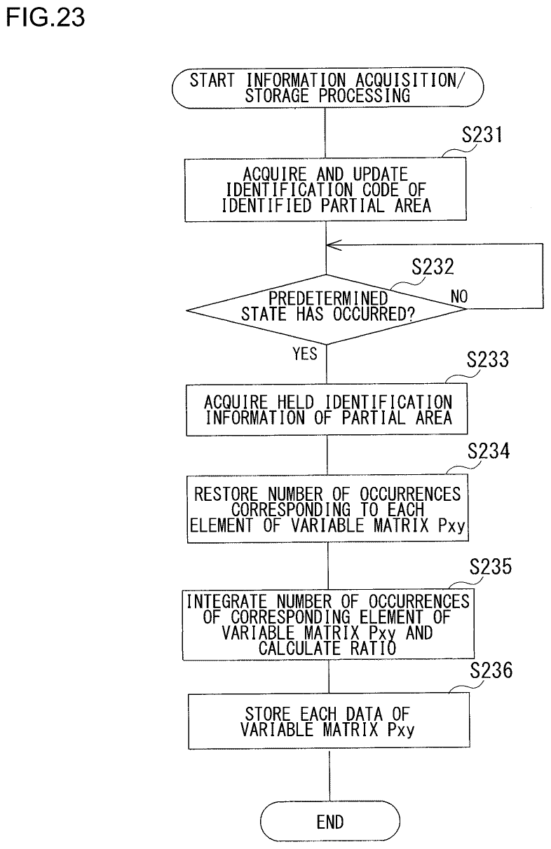

FIG. 23 is a flowchart showing another procedure of the detection information acquisition/storage processing by the information processing device 123. The procedure of the detection information acquisition/storage processing shown in FIG. 23 is based on the data processing method No. 4 shown in FIG. 16. At the start of the processing, the data processing unit 124d first acquires information on the start date and time from the timer and stores it in the storage 125.

Similarly to step S201 shown in FIG. 17, the detection information acquirer 124c of the information processing device 123 sequentially acquires and updates the identification code of the partial area identified on the basis of the address of the detection spot 161 input from the opening/closing processing unit 124a (S231).

Further, similarly to step S202 shown in FIG. 17, the data processing unit 124d determines whether or not the predetermined state has occurred (S232). The data processing unit 124d determines that the predetermined state has occurred when there is an input from the predetermined state detection unit 124b (S232: YES) and requests the detection information acquirer 124c to output the held identification code of the partial area and acquires the identification code (S233). The data processing unit 124d restores the number of occurrences corresponding to each element by using the number Px of occurrences of the predetermined state from the elements (representing the ratio) of the variable matrix Pxy (S234). The data processing unit 124d adds 1 to the elements corresponding to the identification code of the partial area and the identification code of the predetermined state, integrates the number of occurrences, and calculates a ratio of the number of occurrences of each element to the number Px of occurrences of the predetermined state (S235). Note that, for the number Px of occurrences of the predetermined state, the data processing unit 124d performs integration by adding 1 to the number Px of occurrences of any corresponding predetermined state, on the basis of the input from the predetermined state detection unit 124b. The data processing unit 124d stores each data of the variable matrix Pxy in the storage 125 (S236) and ends the processing. In step S232, when there is no input from the predetermined state detection unit 124b, the data processing unit 124d determines that the predetermined state has not occurred (S232: NO) and repeats the determination in step S232.

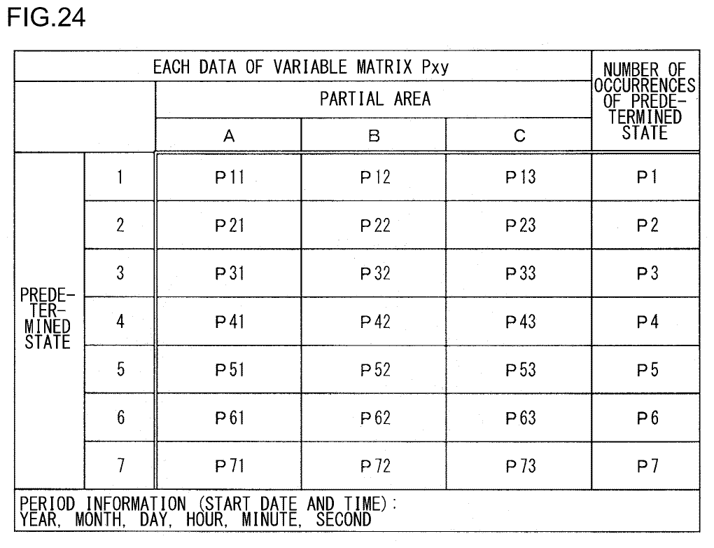

By repeating the processing of steps S231 to S236 shown in FIG. 23 by the data processing unit 124d, for each of the predetermined states of the numbers 1 to 7, the number of occurrences of an event that the detection information has been acquired for each of the partial areas A to C can be stored as a ratio to the number of occurrences of each predetermined state. FIG. 24 is a chart showing an example of information stored by the data processing unit 124d. The stored information shown in FIG. 24 is read by a mobile terminal or a PC via the external connection unit 152, it is possible to efficiently confirm whether or not each predetermined state frequently occurs when the mobile object enters from any of the partial areas A to C, and it is possible to take countermeasures. Since the information stored in the storage 125 by the data processing unit 124d is data of the ratio for each element of the variable matrix Pxy, a numerical value does not increase due to integration, and the capacity required as the storage area can be reduced.

### Fourth Embodiment

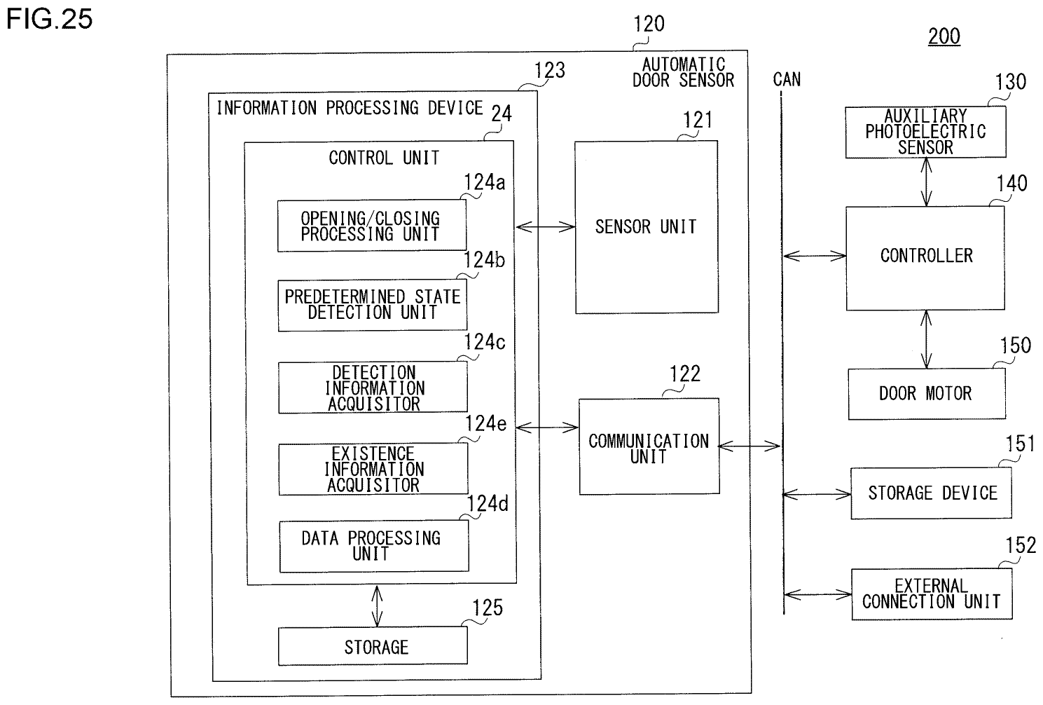

An information processing device 123 according to a fourth embodiment includes an existence information acquirer 124e that acquires detection information in an auxiliary photoelectric sensor 130. FIG. 25 is a block diagram showing a functional configuration of an automatic door system 200 according to the fourth embodiment. In the automatic door system 200 according to the fourth embodiment, configurations and operations other than the existence information acquirer 124e are equivalent to the configurations and the operations described in the third embodiment, and the description thereof is omitted for the sake of brevity.

The existence information acquirer 124e in the information processing device 123 acquires doorway detection information indicating that a mobile object exists on a track of a door 110 from the auxiliary photoelectric sensor 130 and can recognize that the mobile object exists on the track of the door 110 and has passed through an opening 111 of the door 110. When there is an input from a predetermined state detection unit 124b, a data processing unit 124d of the information processing device 123 stores, in a storage 125, occurrence of an event that the doorway detection information has been acquired. As a result, the information processing device 123 determines that the mobile object in a door contact state, a door contact expected state, a stop state, and a stop expected state has passed through the opening 111 of the door 110, on the basis of information recorded in the storage 125.

Further, when the doorway detection information is not acquired by the existence information acquirer 124e after the input from the predetermined state detection unit 124b, the data processing unit 124d may not execute integration processing in data processing methods No. 1 to No. 4 or storage processing on the storage 125. As a result, the information processing device 123 can perform the storage processing on the storage 125 by the data processing unit 124d, except for cases where the mobile object simply crossing in front of the door 110 has been in the door contact state, the door contact expected state, the stop state, and the stop expected state.

On the contrary, when there is the input from the predetermined state detection unit 124b, the data processing unit 124d of the information processing device 123 stores, in the storage 125, occurrence of an event that the doorway detection information has not been acquired. As a result, the information processing device 123 can recognize that the mobile object in the door contact state, the door contact expected state, the stop state, and the stop expected state simply crosses in front of the door 110, on the basis of information recorded in the storage 125.

Further, when the detection information is not acquired by the existence information acquirer 124e after the input from the predetermined state detection unit 124b, the data processing unit 124d may not execute the integration processing in the data processing methods No. 1 to No. 4 or the storage processing on the storage 125. As a result, the information processing device 123 can perform the storage processing on the storage 125 by the data processing unit 124d, for cases where the mobile object simply crossing in front of the door 110 has been in the door contact state, the door contact expected state, the stop state, and the stop expected state.

The existence information acquirer 124e can recognize that the mobile object exists on the track of the door 110 and has passed through the opening 111 of the door 110, on the basis of detection information at detection spots 161 in the vicinity of the door 110, in addition to the detection information from the auxiliary photoelectric sensor 130. The detection spots 161 for detecting that the mobile object exists on the track of the door 110 instead of the auxiliary photoelectric sensor 130 may be, for example, detection spots 161 at addresses 1A to 1L in the vicinity of the door (see FIG. 14). By substituting the auxiliary photoelectric sensor 130 with the detection spots 161 in the vicinity of the door, the information processing device 123 can detect that the mobile object exists in the track of the door 110 in an opening/closing processing unit 124a, and reception processing from the auxiliary photoelectric sensor 130 can be reduced.

### Modification

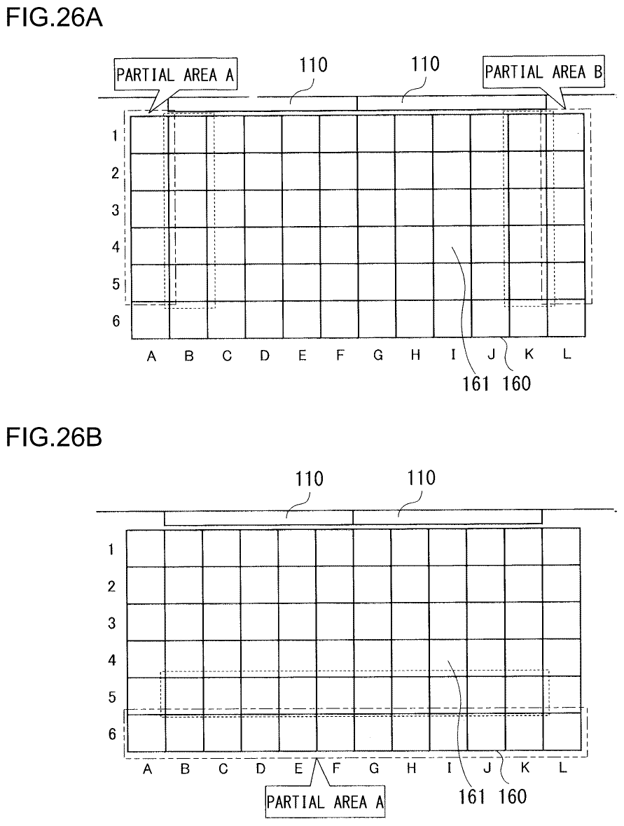

FIG. 26A and FIG. 26B are schematic diagrams showing partial areas set in a detection area 160 of an automatic door sensor 120 according to a modification. The partial areas set in the detection area 160 are not limited to those shown in FIG. 14. In the partial areas shown in FIG. 26A, partial areas A and B are respectively set in leftward and rightward directions toward the door 110, and a partial area is not in front of the door 110. In the partial area shown in FIG. 26B, the partial area A is set in front of the door 110, and partial areas are not set in the leftward and rightward directions toward the door 110.

Further, as shown by dotted lines in FIG. 26A and FIG. 26B, the partial areas set in the peripheral portion of the detection area 160 may be obtained by grouping not only detection spot 161 corresponding to an outer circumferential portion of the detection area 160, but also detection spots 161 (for example, addresses 1B to 5B, 1K to 5K, and 5B to 5K) located inside from the outer circumferential portion of the detection area 160.

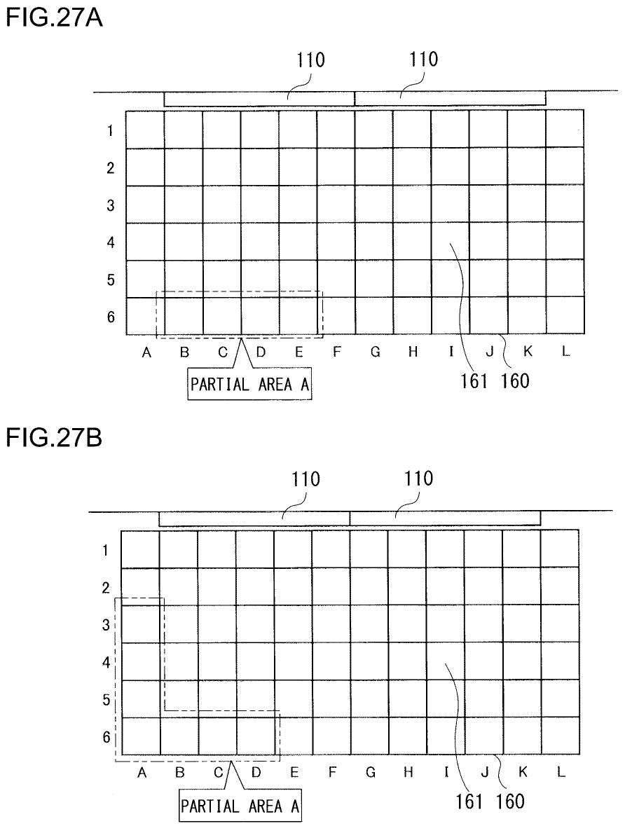

FIG. 27A and FIG. 27B are schematic diagrams showing partial areas set in a detection area 160 of an automatic door sensor 120 according to another modification. In the partial area shown in FIG. 27A, the partial area A is partially set in front of the door 110, and in the partial area shown in FIG. 27B, the partial area A is set in front of the door 110 and in the leftward direction toward the door 110.

Even in any case of FIG. 26A and FIG. 26B, and FIG. 27A and FIG. 27B, one or more partial areas may be set in the detection area 160. Since the information processing device 123 stores occurrence of an event that detection information has been acquired in one or more partial areas where the mobile object enters when a state becomes the predetermined state, the information processing device 123 can efficiently confirm whether or not the predetermined state occurs due to the approach from the partial area, by reading the stored information. Further, according to the information stored by the information processing device 123, when the predetermined state does not occur due to the approach from the set partial area, it is possible to indirectly confirm that the predetermined state occurs due to the approach from a position where the partial area is not set.

Next, features of the information processing device 123 in the third and fourth embodiments and the modification will be described. The inquiry processing device 1 is configured to include the information processing device 123 excluding the opening/closing processing unit 124a and has the features of the information processing device 123. Further, the inquiry processing device 1 is configured as a system in which the information processing device 123 excluding the opening/closing processing unit 124a is provided in the automatic door sensor 120 and the information processing device 123 is included and has the features of the information processing device 123.

The information processing device 123 includes the detection information acquirer 124c that acquires the detection information output when the mobile object is detected in the partial areas A to C set in a part of the detection area 160 provided to detect the mobile object around the door 110 and open/close the door 110 as an operation situation of the door 110, and the storage 125 that stores occurrences of an event that the detection information acquirer 124c has acquired the detection information when the mobile object is in the predetermined state. As a result, by the stored information, the information processing device 123 can support the confirmation of a situation when the mobile object passing the door 110 is in the predetermined state by the stored information.

Further, a plurality of partial areas are provided, and the storage 125 stores the occurrence of the event for each partial area. As a result, by the stored information, the information processing device 123 can confirm from which of the plurality of partial areas the mobile object has been in the predetermined state by passing.

Further, the storage 125 stores the occurrence of the event as the number of occurrences for each partial area. As a result, the information processing device 123 can provide the number of occurrences of the event that the detection information acquirer 124c has acquired the detection information when the mobile object is in the predetermined state. For example, when there are a plurality of partial areas, it is possible to recognize in which partial area the number of occurrences of events is large, and it is possible to take measures for the partial areas with a large number of occurrences.

The storage 125 stores the occurrence of the event as a ratio of the number of occurrences of the event for each partial area to the number of times the detection information acquirer 124c has acquired the detection information for each of the partial areas A to C. As a result, the information processing device 123 can provide the occurrence of the event that the detection information acquirer 124c has acquired the detection information when the mobile object is in the predetermined state as a ratio. For example, when there are a plurality of partial areas, it is possible to recognize in which partial area the frequency of occurrence of events is large, and it is possible to take measures for the partial areas with a large frequency of occurrence.

Further, the storage 125 stores the occurrence of the event as a ratio of the number of occurrences of the event for each partial area to the number of times the mobile object has been in the predetermined state. As a result, the information processing device 123 can provide the occurrence of the event that the detection information acquirer 124c has acquired the detection information when the mobile object is in the predetermined state as a ratio. For example, when there are a plurality of partial areas, it is possible to recognize in which partial area the frequency of occurrence of events is large, and it is possible to take measures for the partial areas with a large frequency of occurrence.

Further, the partial area is set in the peripheral portion of the detection area. As a result, it is possible to grasp in which direction the partial area is located with respect to the door 10.

Further, the existence information acquirer 124e that acquires doorway detection information indicating that the mobile object exists on the track of the door 110 is provided, and the storage 125 stores occurrence of an event that the doorway detection information has been acquired occurs when the mobile object is in the predetermined state. As a result, the information processing device 123 determines that the mobile object in a door contact state, a door contact expected state, a stop state, and a stop expected state has passed through the opening 111 of the door 110, on the basis of information recorded in the storage 125.

Further, the existence information acquirer 124e that acquires the doorway detection information indicating that the mobile object exists on the track of the door 110 is provided, and the storage 125 stores occurrence of an event that the doorway detection information has not been acquired occurs when the mobile object is in the predetermined state. As a result, the information processing device 123 can recognize that the mobile object in the door contact state, the door contact expected state, the stop state, and the stop expected state simply crosses in front of the door 110, on the basis of information recorded in the storage 125.

Further, the partial area is provided in the vicinity of the door 110. As a result, the information processing device 123 can determine whether or not the mobile object has come close to the door 110 and can assumptively determine that the mobile object has passed through the door 110.

Further, the predetermined state is a state in which the mobile object contacts the door 110. As a result, the information processing device 123 can support the confirmation of the situation when the mobile object passing the door 110 contacts the door 110 by the stored information.

Further, the predetermined state is a state in which the mobile object is detected on the track of the door 110 while the door 110 moves in the closing direction. As a result, the information processing device 123 can support the confirmation of the situation when it is expected that the mobile object passing the door 110 contacts the door 110 by the stored information.

Further, the predetermined state is a state in which the mobile object stops in front of the door 110. As a result, the information processing device 123 can support the confirmation of the situation when the mobile object passing the door 110 stops in front of the door 110 by the stored information.

Further, there are a plurality of predetermined states, and the storage 125 stores occurrence of the event for each predetermined state. As a result, the information processing device 123 can support confirmation of the situation when the mobile object passing the door 110 is in the predetermined state for each of the plurality of predetermined states.

### Fifth Embodiment

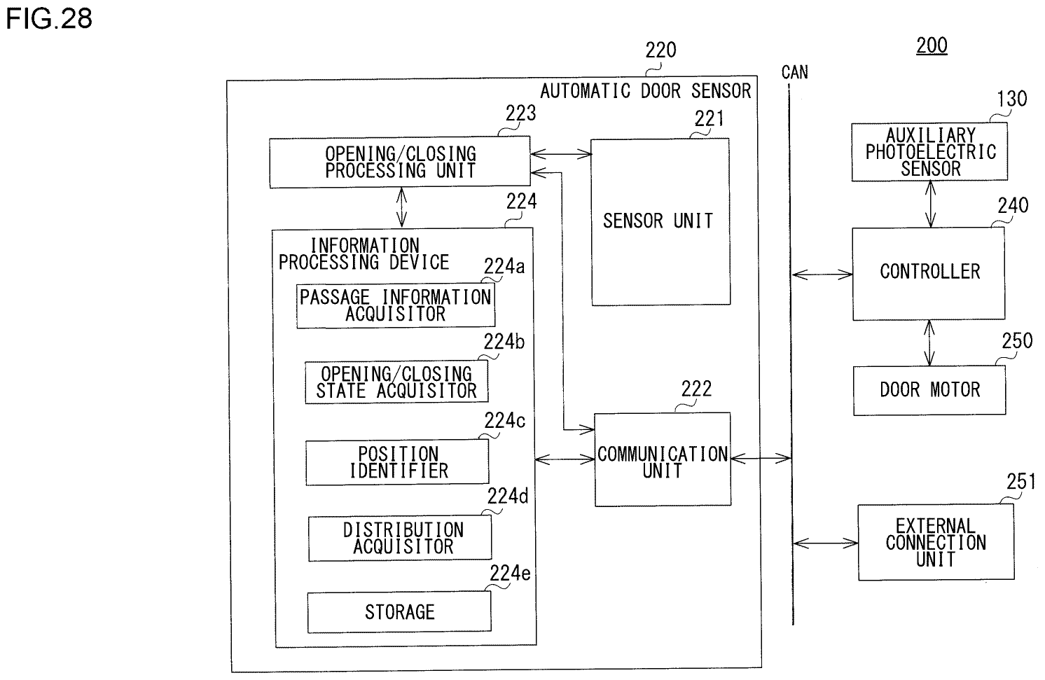

FIG. 28 is a block diagram showing a functional configuration of an automatic door system 200 according to a fifth embodiment. Each block can be realized by electronic elements including a CPU of a computer and mechanical parts in terms of hardware and can be realized by a computer program and the like in terms of software. However, here, the functional blocks realized by their cooperation are drawn. Therefore, those skilled in the art will understand that these functional blocks can be realized in various forms by combining hardware and software.

An automatic door sensor 220, a controller 240, and an external connection unit 251 are connected to be able to communicate with each other by a controller area network (CAN). The communication connection between the automatic door sensor 220, the controller 240, and the external connection unit 51 is not limited to CAN, and wireless communication such as WiFi (registered trademark) may be used.

The automatic door sensor 220 includes a sensor unit 221 as a detection element, a communication unit 222, an opening/closing processing unit 223, and an information processing device 224. The communication unit 222 exchanges data between the controller 240 and the external connection unit 251. The sensor unit 221 is an infrared reflection type sensor and includes a light projector that projects infrared rays onto a detection area described later and a light receiver that receives reflected light from a person or a mobile object.

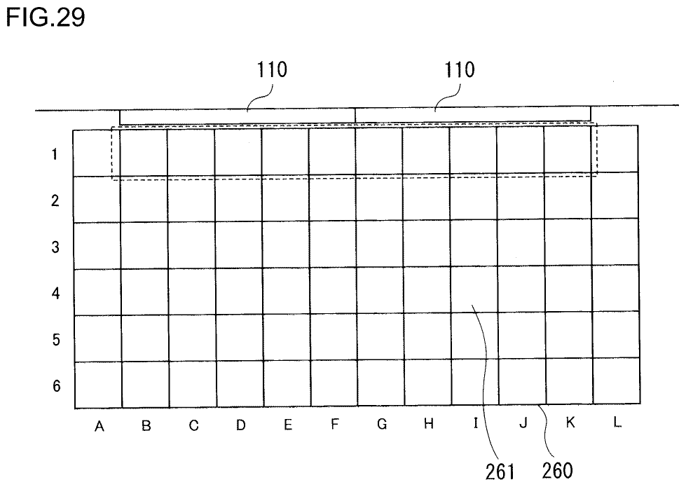

FIG. 29 is a schematic diagram showing a detection area 260 on a floor surface of the sensor unit 221. The detection area 260 is provided around a door 110 and has a three-dimensional range extending from the floor surface to a transom 116 on which the automatic door sensor 220 is disposed or a ceiling. The detection area 260 includes a plurality of detection segments 261 in which 12 rows are arranged in a direction parallel to a moving direction of the door 110 and 6 rows are arranged in a direction orthogonal to the moving direction of the door 110. Addresses 1A, 1B, . . . , 6K, and 6L corresponding to positions of the arrangement are assigned to the detection segments 261, respectively. Each assigned address corresponds to position information of each detection segment 261. A shape of each detection segment 261 and a shape of the entire detection area 260 may be a polygonal shape other than a circular shape, an elliptical shape, and a rectangular shape. Further, the sensor unit 221 may be a radio wave type sensor, an ultrasonic type sensor, a laser scan type sensor, or an image type sensor. The detection segment 261 may have various shapes as described above, and the shape changes depending on the sensor type or the like. The detection segment 261 means an individual area obtained by dividing the detection area 260 into a plurality of portions. On the contrary, it may be considered that the detection area 260 is formed as a whole by the plurality of detection segments 261.

A person or an object is detected in each detection segment 261 of the detection area 260. However, a start segment that generates a start signal for opening and closing the door 110 when the person or the object is detected, and an invalid segment that does not generate a start signal may be set. For example, the detection segments 261 (addresses 1A to 5A, 6A to 6L, and 1L to 5L) located at a peripheral portion of the detection area 260 are set as invalid segments, and the other detection segments 61 are set as start segments. Even when the shape of the detection area 260 is a polygonal shape other than a circular shape, an elliptical shape, and a rectangular shape, the detection segments 261 located at the peripheral portion of the detection area 260 may be set as the invalid segments. The position of the detection segment 261 is not limited to the example using the address described above. The position of the detection segment 261 may be, for example, the coordinates in a coordinate system in a real space defined with the arrangement position of the sensor unit 221 in the transom 116 as the origin. Further, the position of the detection segment 261 may be the coordinates in the coordinate system in the real space defined with an arbitrary position on the floor surface or the like as the origin, and even in any definition, the position of each detection segment 261 may be uniquely grasped.

Returning to FIG. 28, the opening/closing processing unit 223 of the automatic door sensor 220 generates a start signal for opening the door 110 according to a detection result of each detection segment 261, and outputs the start signal to the controller 240 via the communication unit 222.

The opening/closing processing unit 223 monitors a detection level of infrared light corresponding to each detection segment 261 of the sensor unit 221, compares a first threshold lower than a detection level when there is not the person or the object in the detection segment 261 and a second threshold higher than the detection level, and determines whether or there is the person or the object. The opening/closing processing unit 223 sequentially acquires the detection level at each detection segment 261 from the sensor unit 221, and when the detection level becomes equal to or less than the first threshold or equal to or more than the second threshold, the opening/closing processing unit 223 determines that there is the person or the object and generates a start signal.

Further, when the invalid segment is set as described above, the opening/closing processing unit 223 does not generate the start signal even if a detection level at the detection segment 261 set as the invalid segment becomes equal to or less than the first threshold or equal to or more than the second threshold. The opening/closing processing unit 223 outputs an address of the detection segment 261 whose detection level becomes equal to or less than the first threshold or equal to or more than the second threshold to the information processing device 224.

The information processing device 224 of the automatic door sensor 220 has a passage information acquirer 224a, an opening/closing state acquirer 224b, a position identifier 224c, a distribution acquirer 224d, and a storage 224e. The storage 224e is a storage device composed of, for example, a solid state drive (SSD), a hard disk, a CD-ROM, a DVD, an SD card, or the like. The inquiry processing device 1 described on the basis of FIG. 2 may be configured to include the information processing device 224. Further, the inquiry processing device 1 may be considered to be configured as a system in which the information processing device 224 is provided in the automatic door sensor 220 and the information processing device 224 is included.

The passage information acquirer 224a acquires passage information indicating that the person or the object has passed through an opening 111 provided with the door 110 as an operation situation of the door 110, by the detection information acquired from the auxiliary photoelectric sensor 130. As described above, the auxiliary photoelectric sensor 130 outputs detection information indicating that the person or the object exists on a track of the door, and outputs the detection information to the controller 240. The passage information acquirer 224a acquires the detection information of the auxiliary photoelectric sensor 130 acquired via the controller 240 as passage information indicating that the person or the object has passed through the opening 111 provided with the door 110, and outputs the detection information to the position identifier 224c.

Further, when the person or the object is detected in the detection segments 261 (for example, detection segments of addresses 1B to 1K surrounded by a dotted line in FIG. 29) in the vicinity of the door 110 in the detection area 260, the passage information acquirer 224a may determine that the person or the object has passed through the opening 111 provided with the door 110, and may acquire a determination result as passage information. Further, the passage information acquirer 224a may determine that the person or the object has passed through the opening 111 provided with the door 110, on the basis of information of the detection segments 261 in the vicinity of the door 110 in the detection area on the opposite side of the door 110 and may acquire a determination result as passage information.

The opening/closing state acquirer 224b acquires the address of the detection segment 261 in which the person or the object has been detected from the opening/closing processing unit 223 and sets a state in which the address of the detection segment 261 is not input as a closing state of the door 110. The opening/closing state acquirer 224b sets a state in which the address of the detection segment 261 is input from the opening/closing processing unit 223 as an opening state of the door 110. As a result, when the state in which the address of the detection segment 261 is input from the opening/closing processing unit 223 becomes the state in which the address of the detection segment 261 is not input, the opening/closing state acquirer 224b can determine that an opening/closing state of the door 110 changes from the opening state to the closing state. Further, the opening/closing state acquirer 224b acquires the opening/closing state (the opening state or the closing state) of the door 110 from the controller 240 and outputs it to the position identifier 224c.

When the information indicating that the person or the object has passed through the track of the door is not acquired from the passage information acquirer 224a during a period until the opening/closing state of the door 110 input from the opening/closing state acquirer 224b changes from the opening state to the closing state, the position identifier 224c identifies the address of the detection segment 261 in which the person or the object has been detected. When the passage information indicating that the person or the object has passed through the opening 111 cannot be acquired during the period until the state of the door 110 changes from the opening state to the closing state, it may be determined that the door 110 has performed an unnecessary opening/closing operation. When such a case occurs, the position identifier 224c identifies the address of the detection segment 261 in which the person or the object has been detected in the detection area 260 as an approach position and stores the identified address in the storage 224e to investigate the cause of the unnecessary opening/closing operation. For example, when the state changes from the state in which the person or the object has not been detected in the detection area 260 to the state in which the person or the object has been detected, the position identifier 224c identifies the address of the detection segment 261 that has detected the person or the object first as an approach position, and stores the address in the storage 224e.

When the position identifier 224c identifies the address of the detection segment 261 in which the person or the object has been detected, the position identifier 224c can identify the detection segment 261 whose state first has changed from a non-detection state to a detection state at arbitrary timing according to the setting. The position identifier 224c may recognize the detection segments 261 whose state changes from the non-detection state to the detection state after some detection segments 261 are in the detection state as the detection segments that are first in the detection state. For example, when the invalid segment is set in the peripheral portion in the detection area 260, the position identifier 224c identifies the address of the detection segment 261 corresponding to a start segment whose state changes from the non-detection state to the detection state after the invalid segment is in the detection state and stores the address in the storage 224e.

The position identifier 224c stores information on the date and time of occurrence in the storage 224e, in addition to the identified address of the detection segment 261.

Within a predetermined period, the distribution acquirer 224d acquires at least two or more of the addresses of the detection segments 261 in the detection area 260, which is the approach position identified by the position identifier 224c, as distribution information in the detection area 260, and stores the addresses in the storage 24e. The distribution acquirer 224d obtains a distribution by integrating the number of identifications by the position identifier 224c within a predetermined period for each address of the detection segment 261. As the predetermined period, an arbitrary period can be set from an arbitrary start point of time. For example, by setting a period of one month as the predetermined period after installing the automatic door system 200 or setting a period of several months as the predetermined period on a regular basis, it is possible to set a data collection period for investigating the cause of an unnecessary opening/closing operation.

The position identifier 224c and the distribution acquirer 224d may communicate with an external device via the external connection unit 251 and may store the address or distribution data of the detection segment 61, which is the identified approach position, in the external device. By displaying the address or distribution data of the detection segment 261 identified by the position identifier 224c and the distribution acquirer 224d on a handy terminal as the external device or an operation PC connected to a network, support for investigating the cause of the unnecessary opening/closing operation can be enhanced.

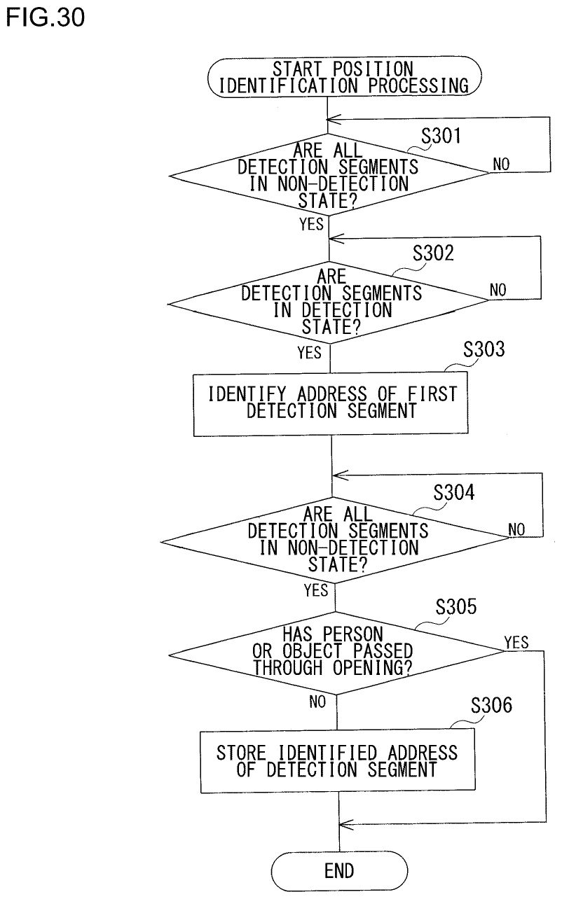

Next, an operation of the automatic door system 200 according to the fifth embodiment will be described on the basis of position identification processing by the information processing device 224. FIG. 30 is a flowchart showing a procedure of the position identification processing by the information processing device 224.

The opening/closing state acquirer 224b of the information processing device 224 determines whether or not all the detection segments 261 are in the non-detection state (S301). When all the detection segments 261 are not in the non-detection state (S301: NO), the determination of step S301 is repeated. When it is determined in the opening/closing state acquirer 224b that all the detection segments 261 are in the non-detection state (S301: YES), this state is determined as a closing state of the door 110, and the position identifier 224c determines whether or not any of the detection segments 261 has been in the detection state, on the basis of the address of the detection segment 261 input from the opening/closing processing unit 223 (S302). When the address of the detection segment 261 is not input from the opening/closing processing unit 223, the position identifier 224c determines that the detection segment 261 is not in the detection state (S302: NO) and repeats the processing of step S302.

When the address of the detection segment 261 is input from the opening/closing processing unit 223, the position identifier 224c determines that the detection segment 261 is in the detection state (S302: YES) and identifies the input address of the detection segment 261 as the approach position (S303). This state is a state in which the person or the object is first detected in the detection area 60 after the door 110 is closed, and the door 110 shifts to the opening state. The opening/closing state acquirer 224b determines whether or not all the detection segments 261 are in the non-detection state (S304). When all the detection segments 261 are not in the non-detection state (S304: NO), the opening/closing state acquirer 224b repeats the determination of step S304.

When it is determined in the opening/closing state acquirer 224b that all the detection segments 261 are in the non-detection state (S304: YES), it is determined that the door 110 is in the closing state. The position identifier 224c determines whether or not the person or the object has passed through the opening 111 provided with the door 110, on the basis of the input from the passage information acquirer 224a (S305). When it is determined that the person or the object has passed through the opening 111 on the basis of the input from the passage information acquirer 224a (S305: YES), the position identifier 224c discards the address of the detection segment 261 identified in step S303 and ends the processing. When it is determined that the person or the object has not passed through the opening 111 on the basis of the input from the passage information acquirer 224a (S305: NO), the position identifier 224c stores the address of the detection segment 261 identified in step S303 in the storage 224e (S306) and ends the processing.

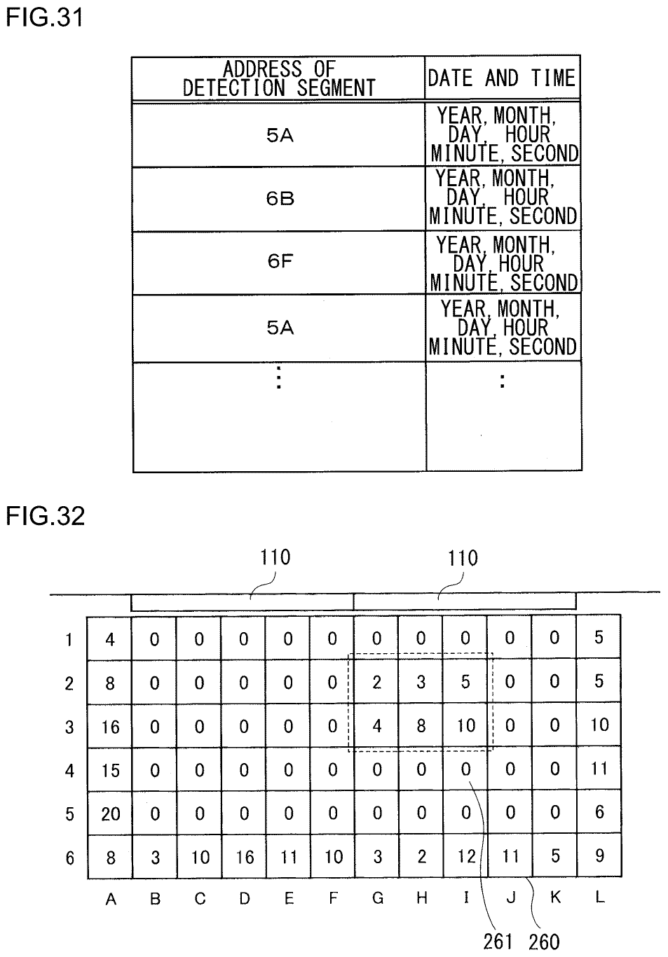

The position identifier 224c or the like of the information processing device 224 repeats the processing of steps S301 to S306 shown in FIG. 30, so that information on the unnecessary opening/closing operation that occurs every moment is stored in the storage 224e. FIG. 31 is a chart showing an example of information stored in the storage 224e. The information stored in the storage 224e includes, for example, the address and the date and time of the detection segment 261. The stored information shown in FIG. 31 is read by a mobile terminal or a PC via the external connection unit 251, and it is possible to efficiently confirm whether or not the unnecessary opening/closing operation frequently occurs after the person or the object is detected in any of the detection segments 261.

As a result, the information processing device 224 can provide the position (address) of the detection segment 261 in the detection state when the unnecessary opening/closing operation occurs and can support the investigation of the cause of the unnecessary opening/closing operation of the door 110. Further, by identifying the address of the detection segment 261 that first has detected the person or the object when a state of the detection area 260 changes from a state where the person or the object is not detected to a state where the person or object is detected, the position identifier 224c can provide information on the approach position of the person or the object when the unnecessary opening/closing operation occurs.

Within a predetermined period, the distribution acquirer 224d acquires at least two or more of the addresses of the detection segments 261 in the detection area 260, which is the approach position identified by the position identifier 224c, as distribution information in the detection area 260, and stores the addresses in the storage 224e. FIG. 32 is a schematic diagram showing an example of distribution by the distribution acquirer 224d.

For example, like the distribution shown in FIG. 32, when the person or the object is detected in the detection segments 261 at addresses 1A to 6A, 6B to 6K, and 1L to 6L, which is the peripheral portion of the detection area 260, and the unnecessary opening/closing operation occurs, it can be determined that the person or the object has crossed or returned in front of the door 110 without passing through the door 110 after entering the detection area 260.

Further, a portion surrounded by a dotted line in FIG. 32 is not the peripheral portion of the detection area 260 but the center portion of the detection area 260 and is the first detection segments 261. Such a case is not a case where the person or the object enters the detection area 260 and crosses in front of the door 110, and it can be determined that erroneous detection may occur due to an external factor.

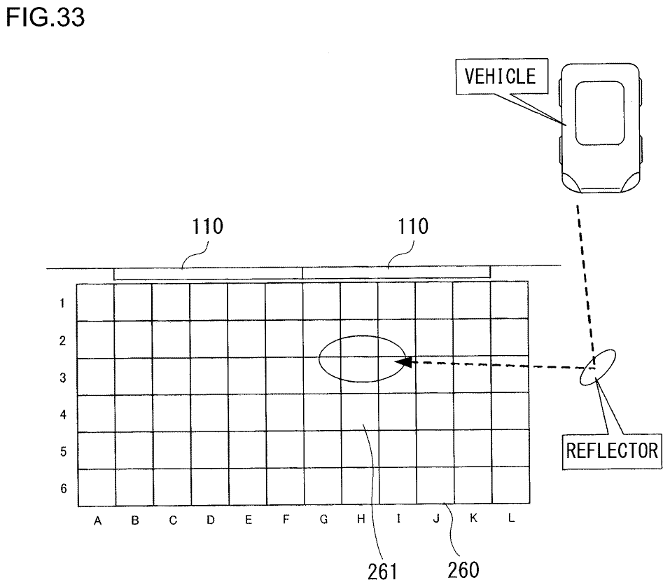

FIG. 33 is a schematic diagram illustrating an example in which an unnecessary opening/closing operation occurs due to an external factor. In an example shown in FIG. 33, light from a headlight of a vehicle is reflected by a reflector and irradiated into the detection area 260, and erroneous detection occurs. When it is found that the unnecessary opening/closing operation occurs due to the external factor, it is possible to take measures such as removing the reflector or the like to prevent the erroneous detection from occurring.

### Modification

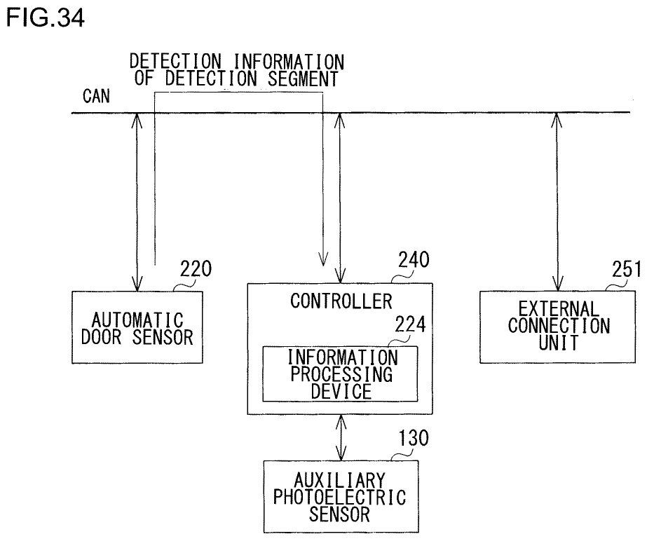

Although the information processing device 224 is provided in the automatic door sensor 220 in the above-described fifth embodiment, the information processing device 224 may be provided in the controller 240. FIG. 34 is a block diagram showing a functional configuration of an automatic door system 200 according to a modification.

As shown in FIG. 34, the information processing device 224 is provided in the controller 240 so that the detection information of the detection segment 261 is output from the automatic door sensor 220 to the controller 240 via communication connection such as CAN. The detection information of the detection segment 261 output from the automatic door sensor 220 is, for example, address information of the detection segment 261 which is in the detection state every moment.

Even when the information processing device 224 is provided in the controller 240, similarly to the fifth embodiment, the position of the detection segment 261 in the detection state when the unnecessary opening/closing operation occurs can be provided, and the investigation of the cause of the unnecessary opening/closing operation can be supported.

Next, features of the information processing device 224 and the automatic door system 200 in the fifth embodiment and the modification will be described. The inquiry processing device 1 is configured to include the information processing device 224 and has the features of the information processing device 224. Further, the inquiry processing device 1 is configured as a system in which the information processing device 224 is provided in the automatic door sensor 220 and the information processing device 224 is included and has the features of the information processing device 224.

The information processing device 224 includes a passage information acquirer 224a, an opening/closing state acquirer 224b, and a position identifier 224c. The passage information acquirer 224a acquires passage information indicating that the person or the object has passed through an opening 111 provided with the door 110, which detects the person or the object in the surrounding detection area 260 and is opened and closed, as an operation situation of the door 110. The opening/closing state acquirer 224b acquires the opening/closing state of the door 110. When the passage information is not acquired by the passage information acquirer 224a during a period until the opening/closing state acquired by the opening/closing state acquirer 224b changes from the opening state to the closing state, the position identifier 224c identifies an approach position which is a position (address of the detection segment 261) where the person or the object has been detected in the detection area 260. As a result, the information processing device 224 can provide the position of the detection segment 261 in the detection state when the unnecessary opening/closing operation occurs and can support the investigation of the cause of the unnecessary opening/closing operation of the door 110.

When the state changes from the state in which the person or the object has not been detected in the detection area 260 to the state in which the person or the object has been detected, the position identifier 224c identifies the detection position (address of the detection segment 261) of the person or the object as an approach position. As a result, the information processing device 224 can provide information on the approach position of the person or the object when the unnecessary opening/closing operation occurs.

Further, the information processing device 224 includes a distribution acquirer 224d that acquires at least two or more of the approach positions (addresses of the detection segments 261) as distribution information in the detection area within a predetermined period. As a result, the information processing device 224 can recognize a range within the detection area 260, which causes the unnecessary opening/closing operation.

Further, the detection area 260 includes a plurality of detection segments 261 for detecting the person or the object. The position identifier 224c identifies the detection segment 261 as the approach position. As a result, the information processing device 224 can identify the position by the detection segment 261.

Further, the distribution acquirer 224d integrates the number of identifications by the position identifier 224c for each detection segment 261 identified as the approach position. As a result, the information processing device 224 can obtain the distribution by the number of detections for each detection segment 261.

The automatic door system 200 includes the automatic door sensor 220, the controller 240, the passage information acquirer 224a, the opening/closing state acquirer 224b, and the position identifier 224c. The automatic door sensor 220 is provided in the opening 111 of the building and detects the person or the object in the detection area 260. The controller 240 opens and closes the door 110 provided in the opening 111, on the basis of the detection state of the automatic door sensor 220. The passage information acquirer 224a acquires passage information indicating that the person or the object has passed through the opening 111. The opening/closing state acquirer 224b acquires the opening/closing state of the door 110. When the passage information is not acquired by the passage information acquirer 224a during a period until the opening/closing state acquired by the opening/closing state acquirer 224b changes from the opening state to the closing state, the position identifier 224c identifies an approach position which is a position (address of the detection segment 261) where the person or the object has been detected in the detection area 260. As a result, the automatic door system 200 can provide the position of the detection segment 261 in the detection state when the unnecessary opening/closing operation occurs and can support the investigation of the cause of the unnecessary opening/closing operation of the door 110. The passage information acquirer 224a, the opening/closing state acquirer 224b, and the position identifier 224c may be provided in the automatic door sensor 220 or may be provided in the controller 240. Further, the passage information acquirer 224a, the opening/closing state acquirer 224b, and the position identifier 224c may be distributed to the automatic door sensor 220 and the controller 240.

The present invention has been described on the basis of the embodiments. The embodiments are merely examples, and it will be understood by those skilled in the art that various modifications and changes can be made within the claims of the present invention, and that the modifications and the changes are also within the claims of the present invention. Therefore, the descriptions and the drawings in the present specification should be treated as exemplary rather than limitative.

What is claimed is:

1. An automatic door system comprising:
a detection information acquirer structured to acquire detection information output when a person or an object is detected in a partial area set in a part of a detection area provided to detect the person or the object around the automatic door and open and close the automatic door; and
a storage structured to store occurrence of an event that the detection information acquirer has acquired the detection information when the person or the object is in a predetermined state.

2. The automatic door system according to claim 1, wherein
a plurality of partial areas are provided, and
the storage stores the occurrence of the event for each partial area.

3. The automatic door system according to claim 1, wherein
the storage stores the occurrence of the event as the number of occurrences for each partial area.

4. The automatic door system according to claim 1, wherein
the storage stores the occurrence of the event as a ratio of the number of occurrences of the event for each partial area to the number of times the detection information acquirer has acquired the detection information for each partial area.

5. The automatic door system according to claim 1, wherein
the storage stores the occurrence of the event as a ratio of the number of occurrences of the event for each partial area to the number of times the person or the object has been in the predetermined state.

6. The automatic door system according to claim 1, wherein
the partial area is set in a peripheral portion of the detection area.

7. The automatic door system according to claim 1, further comprising:
an existence information acquirer structured to acquire doorway detection information indicating that the person or the object exists on a track of the automatic door,
wherein the storage stores occurrence of an event that the doorway detection information has been acquired, when the person or the object is in the predetermined state.

8. The automatic door system according to claim 1, further comprising:
an existence information acquirer structured to acquire doorway detection information indicating that the person or the object exists on a track of the automatic door,
wherein the storage stores occurrence of an event that the doorway detection information has not been acquired, when the person or the object is in the predetermined state.

9. The automatic door system according to claim 1, wherein
the partial area is provided in the vicinity of the automatic door.

10. The automatic door system according to claim 1, wherein
the predetermined state is a state in which the person or the object contacts the automatic door.

11. The automatic door system according to claim 1, wherein
the predetermined state is a state in which the person or the object is detected on the track of the automatic door while the automatic door moves in a closing direction.

12. The automatic door system according to claim 1, wherein
the predetermined state is a state in which the person or the object stops in front of the automatic door.

13. The automatic door system according to claim 1, wherein
there are a plurality of predetermined states, and
the storage stores the occurrence of the event for each predetermined state.

14. An automatic door system comprising:
a passage information acquirer structured to acquire passage information indicating that a person or an object has passed through an opening provided with an automatic door that opens and closes by detecting the person or the object in a detection area around the automatic door,
an opening/closing state acquirer structured to acquire an opening/closing state of the automatic door; and
a position identifier structured to identify approach positions which are positions where the person or the object has been detected in the detection area, when the passage information is not acquired by the passage information acquirer during a period until the opening/closing state acquired by the opening/closing state acquirer changes from an opening state to a closing state.

15. The automatic door system according to claim 14, wherein
when a state changes from a state in which the person or the object has not been detected in the detection area to a state in which the person or the object has been detected, the position identifier identifies positions where the person or the object has been detected as the approach positions.

16. The automatic door system according to claim 14, further comprising:
a distribution acquirer structured to acquire at least two or more of the approach positions as distribution information in the detection area within a predetermined period.

17. The automatic door system according to claim 14, wherein
the detection area includes a plurality of detection segments for detecting the person or the object, and
the position identifier identifies the detection segments as the approach positions.

18. The automatic door system according to claim 16, wherein
the detection area includes a plurality of detection segments for detecting the person or the object,
the position identifier identifies the detection segments as the approach positions, and
the distribution acquirer integrates the number of identifications by the position identifier for each of the detection segments identified as the approach positions.

19. An automatic door system comprising:
an automatic door sensor provided in an opening of a building and detects a person or an object in a detection area,
a controller structured to open and close an automatic door provided in the opening on the basis of the detection state of the automatic door sensor,
a passage information acquirer structured to acquire passage information indicating that the person or the object has passed through the opening,
an opening/closing state acquirer structured to acquire an opening/closing state of the automatic door; and
a position identifier structured to identify approach positions which are positions where the person or the object has been detected in the detection area, when the passage information is not acquired by the passage information acquirer during a period until the opening/closing state acquired by the opening/closing state acquirer changes from an opening state to a closing state.
